(19) United States
(12) Patent Application Publication
(10) Pub. No.: US 2026/0148119 A1
(43) Pub. Date: May 28, 2026

(54) INFORMATION PROCESSING DEVICE, CONTROL DEVICE, AND INFORMATION PROCESSING METHOD

(71) Applicant: NEC Corporation, Tokyo (JP)

(72) Inventor: Yuki SUSA, Tokyo (JP)

(73) Assignee: NEC Corporation, Tokyo (JP)

(21) Appl. No.: 19/364,142

(22) Filed: Oct. 21, 2025

(30) Foreign Application Priority Data
Nov. 26, 2024 (JP) 2024-205114

(51) Int. Cl. G06N 10/40

(52) U.S. Cl. CPC G06N 10/40

(57) ABSTRACT

An information processing device includes a quantum calculation circuit and a controller. The quantum calculation circuit includes a quantum bit element using a parametric oscillator having Kerr nonlinearity. The controller includes a memory storing instructions; and one or more processors configured to execute the instructions to: initialize a quantum state of the quantum bit element in such a way as to indicate any one of binary values of the quantum bit using a coherent drive signal; and then control the quantum calculation circuit in such a way as to increase detuning of the quantum bit element.

This application is based upon and claims the benefit of priority from Japanese Patent Application No. 2024-205114, filed on Nov. 26, 2024, the disclosure of which is incorporated herein in its entirety by reference.

### TECHNICAL FIELD

The present disclosure relates to an information processing device, a control device, an information processing method, and a recording medium.

### BACKGROUND ART

Quantum annealing may be performed using a Kerr parametric oscillator.

For example, JP 2017-073106 A describes that an initial state of a Kerr parametric oscillator is set to a vacuum state, and a pump amplitude of parametric amplification is gradually increased from zero.

### SUMMARY

In a case where a solution candidate is obtained when a solution search for a combination optimization problem or the like is performed using a Kerr parametric oscillator, if the obtained solution candidate can be reflected in the solution search, it is expected that a desired solution can be easily obtained depending on the solution candidate.

An object of the present disclosure is to provide an information processing device, a control device, an information processing method, and a program that can solve the above-described problem.

According to a first aspect of the present disclosure, an information processing device includes a quantum calculation circuit and a controller. The quantum calculation circuit includes a quantum bit element using a parametric oscillator having Kerr nonlinearity. The controller initializes a quantum state of the quantum bit element in such a way as to indicate any one of binary values of the quantum bit using a coherent drive signal, and then controls the quantum calculation circuit in such a way as to increase detuning of the quantum bit element.

According to a second aspect of the present disclosure, a control device includes a controller for controlling a quantum calculation circuit including a quantum bit element using a parametric oscillator having Kerr nonlinearity in such a way that a quantum state of the quantum bit element is initialized to indicate any one of binary values of the quantum bit using a coherent drive signal, and then detuning of the quantum bit element is further increased.

According to a third aspect of the present disclosure, an information processing method includes a computer for controlling a quantum calculation circuit including a quantum bit element having Kerr nonlinearity controlling the quantum calculation circuit to initialize a quantum state of the quantum bit element in such a way as to indicate any one of binary values of the quantum bit using a coherent drive signal, and then increase detuning of the quantum bit element.

According to a fourth aspect of the present disclosure, a program causes a computer for controlling a quantum calculation circuit including a quantum bit element having Kerr nonlinearity to execute controlling the quantum calculation circuit to initialize a quantum state of the quantum bit element in such a way as to indicate any one of binary values of the quantum bit using a coherent drive signal, and then increase detuning of the quantum bit element.

According to the present disclosure, in a case where a solution candidate is obtained when a solution search is performed using a Kerr parametric oscillator, the obtained solution candidate can be reflected in the solution search.

### BRIEF DESCRIPTION OF THE DRAWINGS

FIG. 1 is a diagram illustrating an example of a configuration of an information processing device according to at least one example embodiment;

FIG. 2 is a diagram illustrating an example of a temporal change of a value of each parameter in a first control method according to at least one example embodiment;

FIG. 3 is a diagram illustrating a first example of an initial state of a quantum bit element 110 in the first control method according to at least one example embodiment;

FIG. 4 is a diagram illustrating a second example of the initial state of the quantum bit element 110 in the first control method according to at least one example embodiment;

FIG. 5 is a diagram illustrating an example of an expected value of a position operator of a quantum state of a first quantum bit element in Case 1 by the first control method according to at least one example embodiment;

FIG. 6 is a diagram illustrating an example of an expected value of a position operator of a quantum state of a second quantum bit element in Case 1 by the first control method according to at least one example embodiment;

FIG. 7 is a diagram illustrating an example of variance of position operators of a quantum state of a first quantum bit element in Case 1 by the first control method according to at least one example embodiment;

FIG. 8 is a diagram illustrating an example of variance of position operators of a quantum state of a second quantum bit element in Case 1 by the first control method according to at least one example embodiment;

FIG. 9 is a diagram illustrating an example of an expected value of a position operator of a quantum state of a first quantum bit element in Case 2 by the first control method according to at least one example embodiment;

FIG. 10 is a diagram illustrating an example of an expected value of a position operator of a quantum state of a second quantum bit element in Case 2 by the first control method according to at least one example embodiment;

FIG. 11 is a diagram illustrating an example of variance of position operators of a quantum state of a first quantum bit element in Case 2 by the first control method according to at least one example embodiment;

FIG. 12 is a diagram illustrating an example of variance of position operators of a quantum state of a second quantum bit element in Case 2 by the first control method according to at least one example embodiment;

FIG. 13 is a diagram illustrating an example of an expected value of a position operator of a quantum state of a first quantum bit element in Case 3 by the first control method according to at least one example embodiment;

FIG. 14 is a diagram illustrating an example of an expected value of a position operator of a quantum state of a second quantum bit element in Case 3 by the first control method according to at least one example embodiment;

FIG. 15 is a diagram illustrating an example of variance of position operators of a quantum state of a first quantum bit element in Case 3 by the first control method according to at least one example embodiment;

FIG. 16 is a diagram illustrating an example of variance of position operators of a quantum state of a second quantum bit element in Case 3 by the first control method according to at least one example embodiment;

FIG. 17 is a diagram illustrating an example of an expected value of a position operator of a quantum state of a first quantum bit element in Case 4 by the first control method according to at least one example embodiment;

FIG. 18 is a diagram illustrating an example of an expected value of a position operator of a quantum state of a second quantum bit element in Case 4 by the first control method according to at least one example embodiment;

FIG. 19 is a diagram illustrating an example of variance of position operators of a quantum state of a first quantum bit element in Case 4 by the first control method according to at least one example embodiment;

FIG. 20 is a diagram illustrating an example of variance of position operators of a quantum state of a second quantum bit element in Case 4 by the first control method according to at least one example embodiment;

FIG. 21 is a diagram illustrating an example of a temporal change of a value of each parameter in a second control method according to at least one example embodiment:

FIG. 22 is a diagram illustrating a first example of the initial state of a quantum bit element in the second control method according to at least one example embodiment;

FIG. 23 is a diagram illustrating a second example of the initial state of the quantum bit element in the second control method according to at least one example embodiment;

FIG. 24 is a diagram illustrating an example of an expected value of a position operator of a quantum state of a first quantum bit element in Case 1 by the second control method according to at least one example embodiment;

FIG. 25 is a diagram illustrating an example of an expected value of a position operator of a quantum state of a second quantum bit element in Case 1 by the second control method according to at least one example embodiment;

FIG. 26 is a diagram illustrating an example of variance of position operators of a quantum state of a first quantum bit element in Case 1 by the second control method according to at least one example embodiment;

FIG. 27 is a diagram illustrating an example of variance of position operators of a quantum state of a second quantum bit element in Case 1 by the second control method according to at least one example embodiment;

FIG. 28 is a diagram illustrating an example of an expected value of a position operator of a quantum state of a first quantum bit element in Case 2 by the second control method according to at least one example embodiment;

FIG. 29 is a diagram illustrating an example of an expected value of a position operator of a quantum state of a second quantum bit element in Case 2 by the second control method according to at least one example embodiment;

FIG. 30 is a diagram illustrating an example of variance of position operators of a quantum state of a first quantum bit element in Case 2 by the second control method according to at least one example embodiment;

FIG. 31 is a diagram illustrating an example of variance of position operators of a quantum state of a second quantum bit element in Case 2 by the second control method according to at least one example embodiment;

FIG. 32 is a diagram illustrating an example of an expected value of a position operator of a quantum state of a first quantum bit element in Case 3 by the second control method according to at least one example embodiment;

FIG. 33 is a diagram illustrating an example of an expected value of a position operator of a quantum state of a second quantum bit element in Case 3 by the second control method according to at least one example embodiment;

FIG. 34 is a diagram illustrating an example of variance of position operators of a quantum state of a first quantum bit element in Case 3 by the second control method according to at least one example embodiment;

FIG. 35 is a diagram illustrating an example of variance of position operators of a quantum state of a second quantum bit element in Case 3 by the second control method according to at least one example embodiment;

FIG. 36 is a diagram illustrating an example of an expected value of a position operator of a quantum state of a first quantum bit element in Case 4 by the second control method according to at least one example embodiment;

FIG. 37 is a diagram illustrating an example of an expected value of a position operator of a quantum state of a second quantum bit element in Case 4 by the second control method according to at least one example embodiment;

FIG. 38 is a diagram illustrating an example of variance of position operators of a quantum state of a first quantum bit element in Case 4 by the second control method according to at least one example embodiment;

FIG. 39 is a diagram illustrating an example of variance of position operators of a quantum state of a second quantum bit element in Case 4 by the second control method according to at least one example embodiment;

FIG. 40 is a diagram illustrating a first example of a procedure of processing performed by an information processing device 1 according to at least one example embodiment;

FIG. 41 is a diagram illustrating a second example of a procedure of processing performed by the information processing device 1 according to at least one example embodiment;

FIG. 42 is a diagram illustrating an example of a configuration of an information processing device according to at least one example embodiment;

FIG. 43 is a diagram illustrating an example of a configuration of a control device according to at least one example embodiment;

FIG. 44 is a diagram illustrating an example of a procedure of processing in an information processing method according to at least one example embodiment; and

FIG. 45 is a diagram illustrating an example of a configuration of a computer according to at least one example embodiment.

### EXAMPLE EMBODIMENT

Hereinafter, example embodiments will be described with reference to the drawings.

Hereinafter, the dagger symbol may be expressed by “⁺” (superscript+).

### First Example Embodiment

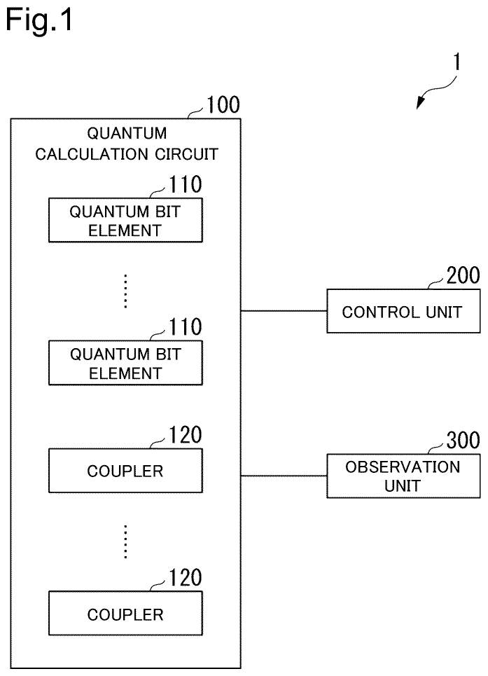

FIG. 1 is a diagram illustrating an example of a configuration of an information processing device according to at least one example embodiment. In the configuration illustrated in FIG. 1, an information processing device 1 includes a quantum calculation circuit 100, a control unit 200, and an observation unit 300. The quantum calculation circuit 100 includes a quantum bit element 110 and a coupler 120.

The quantum bit element 110 is configured using a Kerr-nonlinear parametric oscillator. The Kerr-nonlinear parametric oscillator is a parametric oscillator having Kerr nonlinearity.

The coupler 120 causes a plurality of quantum bit elements 110 to interact with each other under the control of the control unit 200.

The information processing device 1 performs quantum annealing. The quantum annealing herein is to search for an estimated solution of an optimization problem using quantum mechanical properties of a quantum bit element.

The estimated solution herein is a value of a response variable (variable to be solved) in the optimization problem or a quantum bit value representing the response variable value in the optimization problem. The term “estimation” in “estimated solution” means that the solution is not necessarily an optimal solution. The estimated solution is also referred to as a solution candidate or simply as a solution.

One of methods for performing quantum annealing using a Kerr-nonlinear parametric oscillator as a quantum bit element is a method of performing quantum annealing by setting an initial state of the quantum bit element (initial state of quantum state) to a vacuum state.

On the other hand, the information processing device 1 performs quantum annealing by setting the initial state of the quantum bit element 110 to a state indicating some estimated solution. According to the information processing device 1, the estimated solution can be reflected in the solution search by quantum annealing. For example, in a case where the estimated solution set as the initial state of the quantum bit element 110 is relatively close to the optimal solution, according to the information processing device 1, it is expected that the optimal solution can be obtained in a shorter time than a case where quantum annealing is performed by setting the initial state of the quantum bit element to a vacuum state.

Here, setting the estimated solution as the initial state of the quantum bit element 110 means setting the initial state of the quantum bit element 110 to a state indicating the estimated solution.

The estimated solution that the information processing device 1 sets as the initial state of the quantum bit element 110 is not limited to a specific one. For example, the information processing device 1 may set the estimated solution obtained by quantum annealing as the initial state of the quantum bit element 110. Alternatively, the information processing device 1 may set an estimated solution that is considered to be relatively close to the optimal solution, such as an estimated solution obtained manually, as the initial state of the quantum bit element 110. Alternatively, the information processing device 1 may randomly determine the value of the quantum bit set as the initial state of the quantum bit element 110 for each quantum bit element 110 to any of the binary values of the quantum bit.

In a case where a desired solution such as an optimal solution cannot be obtained, the information processing device 1 may change the estimated solution set as the initial state of the quantum bit element 110 to another estimated solution and perform quantum annealing again.

Here, in the case of an information processing device (quantum annealing machine) of a system of creating a quantum superposition state of quantum bit elements using a transverse magnetic field, it is conceivable to set an optimal solution as an initial state of the quantum bit elements, and once bring the state of the quantum bit elements close to the quantum superposition state using the transverse magnetic field to perform quantum annealing.

On the other hand, in an information processing device using a Kerr-nonlinear parametric oscillator as a quantum bit element, a pump signal and a coherent drive signal are input to a quantum bit element, and quantum annealing is performed by controlling a quantum state of the quantum bit element using the pump strength (amplitude of pump signal) and detuning (detuning of Kerr-nonlinear parametric oscillator) as control parameters.

In this case, in the information processing device using the Kerr-nonlinear parametric oscillator as the quantum bit element, the transverse magnetic field is not used, and the operation of bringing the state of the quantum bit element close to the quantum superposition state is not performed.

In this regard, in an information processing device using a Kerr-nonlinear parametric oscillator as a quantum bit element, whether it is possible to perform quantum annealing by setting an estimated solution as an initial state of the quantum bit element, and if possible, the method of performing quantum annealing are unknown.

Against this background, the inventor of the present application has found that in an information processing device using a Kerr-nonlinear parametric oscillator as a quantum bit element, quantum annealing can be performed by setting an estimated solution as an initial state of the quantum bit element, and has also found the execution method thereof.

The control unit 200 controls the quantum calculation circuit 100 to execute quantum annealing.

In particular, the control unit 200 inputs the pump signal and the coherent drive signal to the quantum bit element 110 to control the state of the quantum bit element 110.

At the start of quantum annealing (at the start of one solution search by quantum annealing), the control unit 200 uses a coherent drive signal to set an estimated solution as an initial state of the quantum bit element 110.

The control unit 200 also controls the coupling strength of the quantum bit element 110 by the coupler 120 (strength of interaction of quantum bit element 110).

The control unit 200 corresponds to an example of a controller.

The control unit 200 may be configured using a Neumann computer.

The information processing device 1 corresponds to an example of a control device in that the information processing device 1 includes the control unit 200. Alternatively, a control device may be provided separately from a quantum calculation circuit 611, and the control device may include the control unit 200.

The control unit 200 controls the quantum calculation circuit 100 to execute quantum annealing, for example, based on a Hamiltonian H shown in Formula (1).

$$\begin{matrix}[ Math . 1 ] & \\ H = {\sum }_{i = 1}^{N} [ Δ ( t ) {a}_{i}^{†} {a}_{i} + \frac{K}{2} {( {a}_{i}^{†} )}^{2} {( {a}_{i} )}^{2} - \frac{p ( t )}{2} ( {( {a}_{i}^{†} )}^{2} + {( {a}_{i} )}^{2} ) - C ( t ) \frac{{ε}_{i}}{2} ( {a}_{i}^{†} + {a}_{i} ) ] + B ( t ) [ {\sum }_{i = 1}^{N - 1} {\sum }_{j = i + 1}^{N} {J}_{i j} ( {a}_{i}^{†} {a}_{j} + {a}_{i} {a}_{j}^{†} ) + {\sum }_{i = 1}^{N} {h}_{i} ( {a}_{i}^{†} + {a}_{i} ) ] & ( 1 )\end{matrix}$$

N is an integer of N≥1 indicating the number of quantum bit elements 110. In Formula (1), i and j both represent identification numbers for identifying the N quantum bit elements 110, and are integers of 1≤i and j≤N. The quantum bit element 110 identified by the identification number i is also referred to as an i-th quantum bit element 110.

Here, t represents a time in one quantum annealing (one solution search by quantum annealing). The start time of quantum annealing is defined as time 0, and the end time of quantum annealing is defined as time T. Time T represents a quantum annealing time.

Here, Δ(t) represents detuning at time t. The detuning of the Kerr-nonlinear parametric oscillator is a deviation of the oscillation frequency of the Kerr-nonlinear parametric oscillator from the resonance frequency.

Here, a⁺ᵢ represents a creation operator in the i-th quantum bit element 110.

Here, aᵢ represents an annihilation operator in the i-th quantum bit element 110.

Then, K represents Kerr-nonlinearity.

Also, p (t) represents the pump strength at time t. The pump strength is indicated by the amplitude of a pump signal input to the quantum bit element 110. The pump signal is a signal that functions as a pump in parametric oscillation.

Here, εᵢ represents a quantum bit value set as an initial state in the i-th quantum bit element 110. Also, εᵢ takes a value of −1 or +1.

Here, “C (t) (εᵢ/2) (a⁺ᵢ+aᵢ)” is a term of the Hamiltonian for initialization of the quantum bit element 110. As the value of the coefficient C (t) increases, the control of the initial state setting for the quantum bit element 110 becomes stronger.

The value of the coefficient C (t) is reflected in, for example, the intensity of a coherent drive signal input to the quantum bit element 110. The coherent drive signal is a signal for adjusting a coherent state of the quantum bit element 110. The control unit 200 weakens the intensity of the coherent drive signal as the value of the coefficient C (t) is smaller. The control unit 200 may input a coherent drive having an intensity proportional to the value of the coefficient C (t) to the quantum bit element 110.

Here, “B (t) [Σᵢ₌₁^{N-1}Σⱼ₌ᵢ₊₁^{N}Jᵢⱼ j (a⁺ᵢaⱼ+aᵢa⁺ⱼ)+Σᵢ₌₁^{N}hᵢ (a⁺ᵢ+aᵢ)]” is a term of the Hamiltonian indicating the optimization problem to be solved. As the value of the coefficient B (t) increases, control for searching for the estimated solution according to the optimization problem for the quantum bit element 110 becomes stronger. The value of the coefficient B (t) is reflected in, for example, the coupling strength of the quantum bit element 110 by the coupler 120.

The coefficient Jᵢⱼ is related to a coefficient of a second-order term (term based on product of two binary variables) in the optimization problem.

The coefficient hᵢ is related to a coefficient of a first-order term (term based on one binary variable) in the optimization problem.

The observation unit 300 observes the state of the quantum bit element 110 to obtain an estimated solution obtained by quantum annealing.

The control unit 200 may set the estimated solution obtained by the observation unit 300 as the initial state of the quantum bit element 110 and cause the quantum calculation circuit 100 to perform quantum annealing again.

The control unit 200 may once decrease and then increase the pump strength (amplitude of pump signal input to quantum bit element 110). Alternatively, the control unit 200 may increase the pump strength from 0 or sufficiently low strength.

The control method by which the control unit 200 once decreases and then increases the pump strength is also referred to as a first control method.

The control method by which the control unit 200 increases the pump strength from 0 or sufficiently low strength is also referred to as a second control method.

### (First Control Method)

As an example of the first control method, an experiment by simulation was performed for a case of using the Hamiltonian H shown in Formula (2).

$$\begin{matrix}[ Math . 2 ] & \\ H = {\sum }_{i = 1}^{2} [ Γ sin ( \frac{π t}{T} ) {a}_{i}^{†} {a}_{i} + \frac{K}{2} {( {a}_{i}^{†} )}^{2} {( {a}_{i} )}^{2} - \frac{{p}_{1}}{2} ( 1 - Γ sin ( \frac{π t}{T} ) ) ( {( {a}_{i}^{†} )}^{2} + {( {a}_{i} )}^{2} ) - ( 1 - \frac{t}{T} ) \frac{{ε}_{i}}{2} ( {a}_{i}^{†} + {a}_{i} ) ] + \frac{t}{T} [ - ( {a}_{1}^{†} {a}_{2} + {a}_{1} {a}_{2}^{†} ) - ( {a}_{1}^{†} + {a}_{1} ) ] & ( 2 )\end{matrix}$$

Formula (2) is obtained by setting as follows in Formula (1).

The number N of quantum bit elements 110=2,
detuning Δ (t)=Γ sin (πt/T),
pump strength p (t)=p₁ (1−Γ sin (πt/T)),
the coefficient C (t) of the term of the Hamiltonian for the initialization of the quantum bit element 110=1−t/T,
the coefficient B (t) of the term of the Hamiltonian indicating the optimization problem to be solved=t/T,
coefficient J₁₂=−1,
coefficient h₁=−1, coefficient h₂=0.

Here, Γ is a constant of Γ>0.

The Kerr nonlinearity K was set to 1, and the initial value P₁ of the pump strength was set to 4.

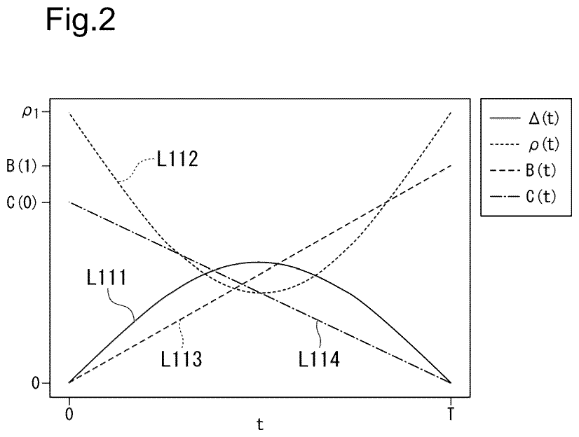

FIG. 2 is a diagram illustrating an example of a temporal change of a value of each parameter in the first control method. FIG. 2 illustrates an example of the temporal change of a value of each parameter in a case where the Hamiltonian illustrated in Formula (2) is used.

The horizontal axis of the graph in FIG. 2 indicates the time in one quantum annealing. As described above, time 0 indicates the start of quantum annealing. Time T indicates the end of quantum annealing.

The vertical axis of the graph of FIG. 2 indicates the value of the parameter.

A line L111 indicates the detuning Δ (t) for each time t. In the example of FIG. 2, the control unit 200 sets the initial value of the detuning Δ (t) to 0, once increases the detuning Δ (t) according to the lapse of time, and then decreases the detuning Δ (t) to 0.

A line L112 indicates the pump strength p (t) for each time t. In the example of FIG. 2, the control unit 200 once decreases the pump strength p (t) from the initial value p₁ and then increases the pump strength p (t) to p₁.

A line L113 indicates the value of the coefficient B (t) of the term of the Hamiltonian indicating the optimization problem to be solved for each time t. In the example of FIG. 2, the control unit 200 increases the value of the coefficient B (t) from 0 to the final value B (1). The final value B (1) may be a predetermined value.

A line L114 indicates the value of the coefficient C (t) of the term of the Hamiltonian for initialization of the quantum bit element 110 for each time t. In the example of FIG. 2, the control unit 200 decreases the value of the coefficient C (t) from the initial value C (0) to 0. The initial value C (0) of the coefficient C (t) may be a predetermined value.

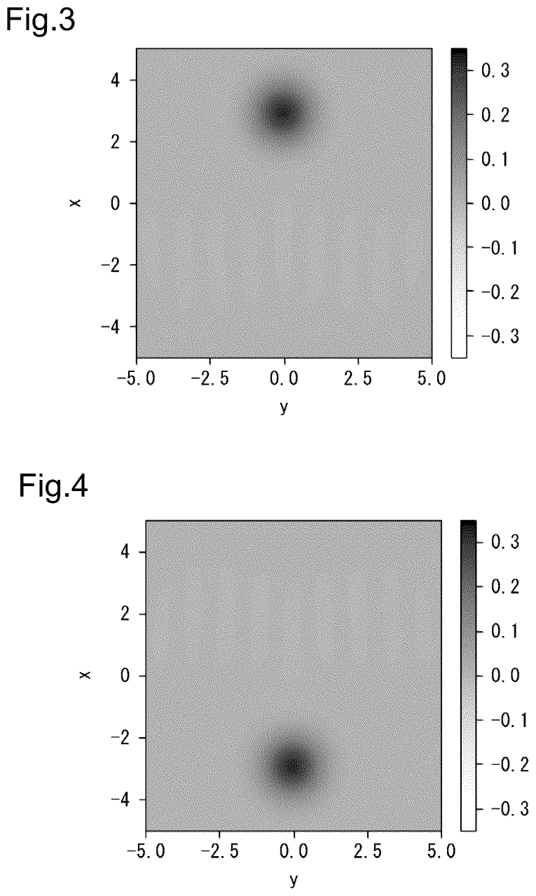

FIG. 3 is a diagram illustrating a first example of the initial state of the quantum bit element 110 in the first control method. FIG. 3 illustrates a plot of a Wigner function in a case where the initial state of the i-th quantum bit element 110 is set to εᵢ=+1.

The horizontal axis (y coordinate) of the graph of FIG. 3 indicates an expected value <p> for a momentum operator p of the quantum state of the quantum bit element 110. The vertical axis (x coordinate) indicates an expected value <x> for a position operator x of the quantum state of the quantum bit element 110.

In this case, the initial state of the i-th quantum bit element 110 is a coherent state of |+α₁>ᵢ. The subscript index “1” in “α” indicates the eigenvalue for the annihilation operator “a” of the coherent states generated under the initial Hamiltonian discussed here. Specifically, α₁=√(p₁/K), and “α₁” is written in accordance with the suffix “1” of “p₁”.

In the example of FIG. 3, the function value is plotted at a position relatively away from x=0 in the positive area of the x coordinate. In the initial setting of the parameter value illustrated in FIG. 2, the pump strength is sufficiently increased with respect to the detuning, and the value of the coefficient C (t) is sufficiently increased with respect to the value of the coefficient B (t), so that the state of εᵢ=+1 can be regarded as being relatively strongly reflected as the initial state of the quantum bit element 110.

The example of FIG. 3 corresponds to an example in which the quantum state of the quantum bit element 110 is initialized in such a way as to indicate a value of +1 out of +1 and −1, which are binary values of the quantum bits.

The expected value <x> of the position operator x can be regarded as representing the quantum bit value indicated by the quantum state of the quantum bit element 110. In a case where the expected value <x> is a positive value, “+1” of the quantum bit value is indicated. In a case where the expected value <x> is a negative value, “−1” of the quantum bit value is indicated. The magnitude (absolute value) of the expected value <x> can be regarded as indicating the strength with which the quantum state of the quantum bit element 110 indicates the quantum bit value.

A variance √(<x²>−<x>²) of the position operator x can be regarded as representing the likelihood that the quantum bit value is correctly read from the quantum state of the quantum bit element 110. As the variance √(<x²>−<x>²) is larger, it can be regarded that there is a higher possibility that the quantum bit value is erroneously read from the quantum state of the quantum bit element 110.

As the magnitude (absolute value) of the expected value <x> is smaller, it can be regarded that there is a higher possibility that the quantum bit value is erroneously read from the quantum state of the quantum bit element 110.

FIG. 4 is a diagram illustrating a second example of the initial state of the quantum bit element 110 in the first control method. FIG. 4 illustrates a plot of a Wigner function in a case where the initial state of the i-th quantum bit element 110 is set to εᵢ=−1.

The horizontal axis (y coordinate) of the graph of FIG. 4 indicates the expected value <p> for the momentum operator p of the quantum state of the quantum bit element 110. The vertical axis (x coordinate) indicates the expected value <x> for the position operator x of the quantum state of the quantum bit element 110.

In this case, the initial state of the i-th quantum bit element 110 is a coherent state of |−α₁>ᵢ.

In the example of FIG. 4, the function value is plotted at a position relatively away from x=0 in the negative area of the x coordinate. In the initial setting of the parameter value illustrated in FIG. 2, the pump strength is sufficiently increased with respect to the detuning, and the value of the coefficient C (t) is sufficiently increased with respect to the value of the coefficient B (t), so that the state of εᵢ=−1 can be regarded as being relatively strongly reflected as the initial state of the quantum bit element 110.

The example of FIG. 4 corresponds to an example in which the quantum state of the quantum bit element 110 is initialized in such a way as to indicate a value of −1 out of +1 and −1, which are binary values of the quantum bits.

In the first control method,
Case 1: the initial state ε₁ of the first quantum bit element 110=+1, the initial state P₂ of the second quantum bit element 110=+1,
Case 2: the initial state ε₁ of the first quantum bit element 110=+1, the initial state P₂ of the second quantum bit element 110=−1,
Case 3: the initial state ε₁ of the first quantum bit element 110=−1, the initial state P₂ of the second quantum bit element 110=+1,
Case 4: the initial state P₁ of the first quantum bit element 110=−1, the initial state P₂ of the second quantum bit element 110=−1,
for each case, the value of a constant Γ in Formula (2) was variously set, and quantum annealing was performed for different quantum annealing times to calculate the expected value and variance of the position operator of the quantum state of the quantum bit element 110.

Here, the quantum annealing time is represented by a dimensionless quantity normalized by the reciprocal of the Kerr coefficient. For example, when the Kerr coefficient is 1 megahertz (MHz), the quantum annealing time T=1 corresponds to 1 microsecond (s).

(First Control Method, Case 1 (ε₁=+1, ε₂=+1))

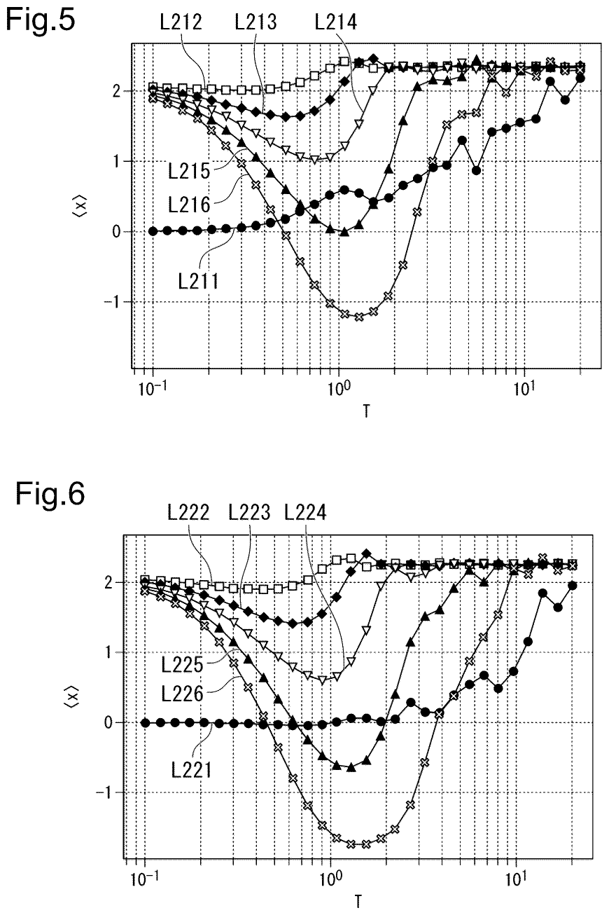

FIG. 5 is a diagram illustrating an example of an expected value of a position operator of a quantum state of the first quantum bit element 110 in Case 1 by the first control method.

The horizontal axis of the graph of FIG. 5 indicates the quantum annealing time. The vertical axis indicates the expected value <x> of the position operator x of the quantum state of the first quantum bit element 110 at the end of quantum annealing.

A line L211 indicates the expected value of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L211 is illustrated for comparison with cases where an estimated solution is set as the initial state of the quantum bit element 110, indicated by lines L212 to L216.

The line L212 indicates the expected value of the position operator of the quantum state of the first quantum bit element 110 at the end of quantum annealing for each quantum annealing time in the case of Γ=0.2.

The line L213 indicates the expected value of the position operator of the quantum state of the first quantum bit element 110 at the end of quantum annealing for each quantum annealing time in the case of Γ=0.4.

The line L214 indicates the expected value of the position operator of the quantum state of the first quantum bit element 110 at the end of quantum annealing for each quantum annealing time in the case of Γ=0.6.

The line L215 indicates the expected value of the position operator of the quantum state of the first quantum bit element 110 at the end of quantum annealing for each quantum annealing time in the case of Γ=0.8.

The line L216 indicates the expected value of the position operator of the quantum state of the first quantum bit element 110 at the end of quantum annealing for each quantum annealing time in the case of Γ=1.0.

FIG. 6 is a diagram illustrating an example of an expected value of a position operator of a quantum state of the second quantum bit element 110 in Case 1 by the first control method.

The horizontal axis of the graph of FIG. 6 indicates the quantum annealing time. The vertical axis indicates the expected value <x> of the position operator x of the quantum state of the second quantum bit element 110 at the end of quantum annealing.

A line L221 indicates the expected value of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L221 is illustrated for comparison with cases where an estimated solution is set as the initial state of the quantum bit element 110, indicated by lines L222 to L226.

The line L222 indicates the expected value of the position operator of the quantum state of the second quantum bit element 110 at the end of quantum annealing for each quantum annealing time in the case of Γ=0.2.

The line L223 indicates the expected value of the position operator of the quantum state of the second quantum bit element 110 at the end of quantum annealing for each quantum annealing time in the case of Γ=0.4.

The line L224 indicates the expected value of the position operator of the quantum state of the second quantum bit element 110 at the end of quantum annealing for each quantum annealing time in the case of Γ=0.6.

The line L225 indicates the expected value of the position operator of the quantum state of the second quantum bit element 110 at the end of quantum annealing for each quantum annealing time in the case of Γ=0.8.

The line L226 indicates the expected value of the position operator of the quantum state of the second quantum bit element 110 at the end of quantum annealing for each quantum annealing time in the case of Γ=1.0.

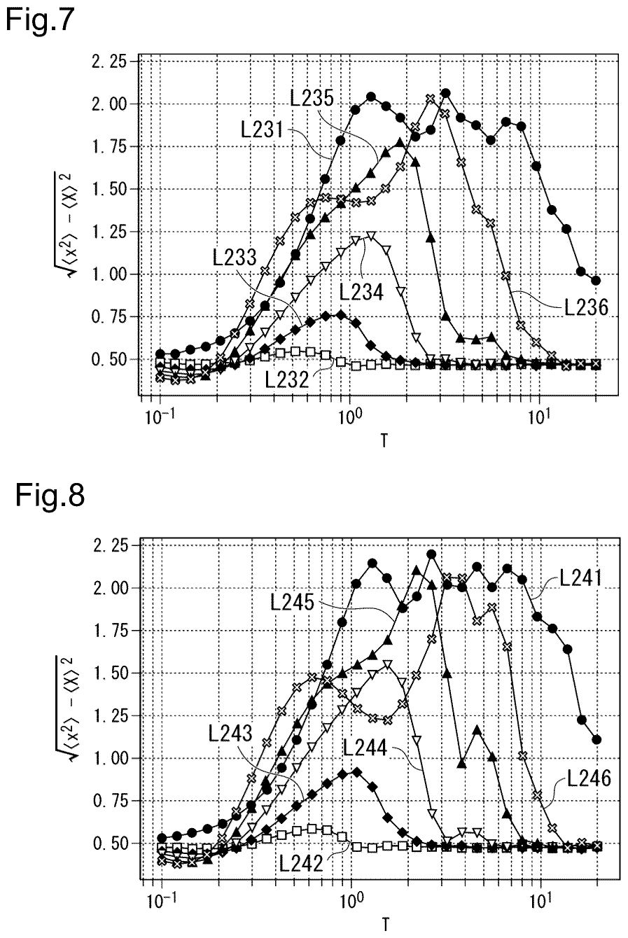

FIG. 7 is a diagram illustrating an example of variance of position operators of a quantum state of the first quantum bit element 110 in Case 1 by the first control method.

The horizontal axis of the graph of FIG. 7 indicates the quantum annealing time. The vertical axis indicates the variance √(<x²>−<x>²) of the position operator x of the quantum state of the first quantum bit element 110 at the end of quantum annealing.

A line L231 indicates the variance of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L231 is illustrated for comparison with cases where an estimated solution is set as the initial state of the quantum bit element 110, indicated by lines L232 to L236.

The line L232 indicates the variance of the position operator of the quantum state of the first quantum bit element 110 at the end of quantum annealing for each quantum annealing time in the case of Γ=0.2.

The line L233 indicates the variance of the position operator of the quantum state of the first quantum bit element 110 at the end of quantum annealing for each quantum annealing time in the case of Γ=0.4.

The line L234 indicates the variance of the position operator of the quantum state of the first quantum bit element 110 at the end of quantum annealing for each quantum annealing time in the case of Γ=0.6.

The line L235 indicates the variance of the position operator of the quantum state of the first quantum bit element 110 at the end of quantum annealing for each quantum annealing time in the case of Γ=0.8.

The line L236 indicates the variance of the position operator of the quantum state of the first quantum bit element 110 at the end of quantum annealing for each quantum annealing time in the case of Γ=1.0.

FIG. 8 is a diagram illustrating an example of variance of position operators of a quantum state of the second quantum bit element 110 in Case 1 by the first control method.

The horizontal axis of the graph of FIG. 8 indicates the quantum annealing time. The vertical axis indicates the variance √(<x²>−<x>²) of the position operator x of the quantum state of the second quantum bit element 110 at the end of quantum annealing.

A line L241 indicates the variance of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L241 is illustrated for comparison with cases where an estimated solution is set as the initial state of the quantum bit element 110, indicated by lines L242 to L246.

The line L242 indicates the variance of the position operator of the quantum state of the second quantum bit element 110 at the end of quantum annealing for each quantum annealing time in the case of Γ=0.2.

The line L243 indicates the variance of the position operator of the quantum state of the second quantum bit element 110 at the end of quantum annealing for each quantum annealing time in the case of Γ=0.4.

The line L244 indicates the variance of the position operator of the quantum state of the second quantum bit element 110 at the end of quantum annealing for each quantum annealing time in the case of Γ=0.6.

The line L245 indicates the variance of the position operator of the quantum state of the second quantum bit element 110 at the end of quantum annealing for each quantum annealing time in the case of Γ=0.8.

The line L246 indicates the variance of the position operator of the quantum state of the second quantum bit element 110 at the end of quantum annealing for each quantum annealing time in the case of Γ=1.0.

(First Control Method, Case 2 (ε₁=+1, ε₂=−1))

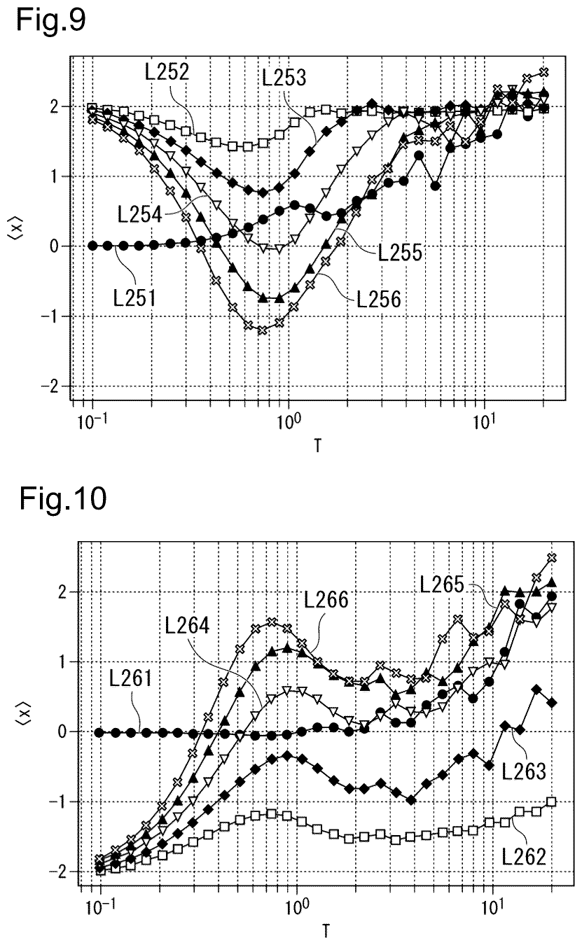

FIG. 9 is a diagram illustrating an example of an expected value of a position operator of a quantum state of the first quantum bit element 110 in Case 2 by the first control method.

The horizontal axis of the graph of FIG. 9 indicates the quantum annealing time. The vertical axis indicates the expected value <x> of the position operator x of the quantum state of the first quantum bit element 110 at the end of quantum annealing.

A line L251 indicates the expected value of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L251 is illustrated for comparison with cases where an estimated solution is set as the initial state of the quantum bit element 110, indicated by lines L252 to L256.

The line L252 indicates the expected value of the position operator of the quantum state of the first quantum bit element 110 at the end of quantum annealing for each quantum annealing time in the case of Γ=0.2.

The line L253 indicates the expected value of the position operator of the quantum state of the first quantum bit element 110 at the end of quantum annealing for each quantum annealing time in the case of Γ=0.4.

The line L254 indicates the expected value of the position operator of the quantum state of the first quantum bit element 110 at the end of quantum annealing for each quantum annealing time in the case of Γ=0.6.

The line L255 indicates the expected value of the position operator of the quantum state of the first quantum bit element 110 at the end of quantum annealing for each quantum annealing time in the case of Γ=0.8.

The line L256 indicates the expected value of the position operator of the quantum state of the first quantum bit element 110 at the end of quantum annealing for each quantum annealing time in the case of Γ=1.0.

FIG. 10 is a diagram illustrating an example of an expected value of a position operator of a quantum state of the second quantum bit element 110 in Case 2 by the first control method.

The horizontal axis of the graph of FIG. 10 indicates the quantum annealing time. The vertical axis indicates the expected value <x> of the position operator x of the quantum state of the second quantum bit element 110 at the end of quantum annealing.

A line L261 indicates the expected value of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L261 is illustrated for comparison with cases where an estimated solution is set as the initial state of the quantum bit element 110, indicated by lines L262 to L266.

The line L262 indicates the expected value of the position operator of the quantum state of the second quantum bit element 110 at the end of quantum annealing for each quantum annealing time in the case of Γ=0.2.

The line L263 indicates the expected value of the position operator of the quantum state of the second quantum bit element 110 at the end of quantum annealing for each quantum annealing time in the case of Γ=0.4.

The line L264 indicates the expected value of the position operator of the quantum state of the second quantum bit element 110 at the end of quantum annealing for each quantum annealing time in the case of Γ=0.6.

The line L265 indicates the expected value of the position operator of the quantum state of the second quantum bit element 110 at the end of quantum annealing for each quantum annealing time in the case of Γ=0.8.

The line L266 indicates the expected value of the position operator of the quantum state of the second quantum bit element 110 at the end of quantum annealing for each quantum annealing time in the case of Γ=1.0.

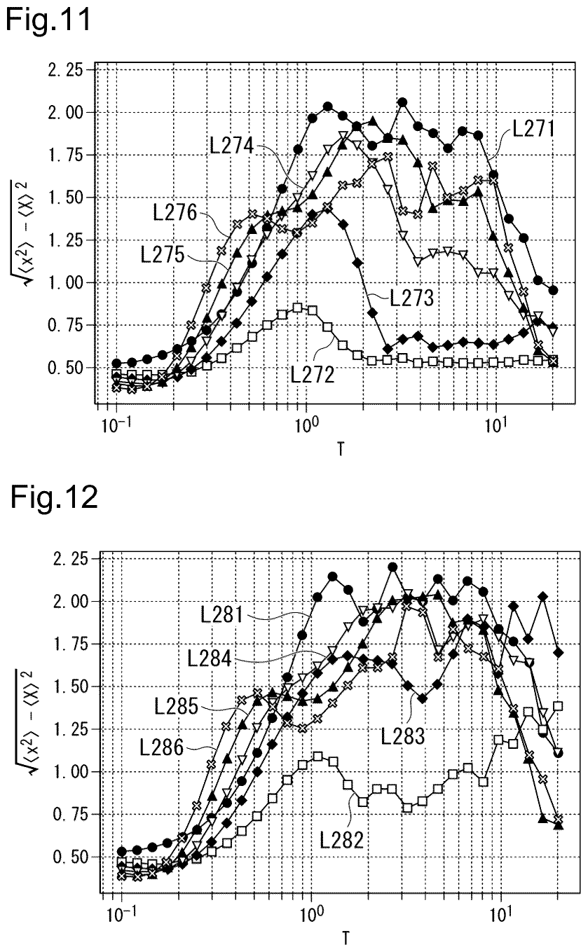

FIG. 11 is a diagram illustrating an example of variance of position operators of a quantum state of the first quantum bit element 110 in Case 2 by the first control method.

The horizontal axis of the graph of FIG. 11 indicates the quantum annealing time. The vertical axis indicates the variance √(<x²>−<x>²) of the position operator x of the quantum state of the first quantum bit element 110 at the end of quantum annealing.

A line L271 indicates the variance of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L271 is illustrated for comparison with cases where an estimated solution is set as the initial state of the quantum bit element 110, indicated by lines L272 to L276.

The line L272 indicates the variance of the position operator of the quantum state of the first quantum bit element 110 at the end of quantum annealing for each quantum annealing time in the case of Γ=0.2.

The line L273 indicates the variance of the position operator of the quantum state of the first quantum bit element 110 at the end of quantum annealing for each quantum annealing time in the case of Γ=0.4.

The line L274 indicates the variance of the position operator of the quantum state of the first quantum bit element 110 at the end of quantum annealing for each quantum annealing time in the case of Γ=0.6.

The line L275 indicates the variance of the position operator of the quantum state of the first quantum bit element 110 at the end of quantum annealing for each quantum annealing time in the case of Γ=0.8.

The line L276 indicates the variance of the position operator of the quantum state of the first quantum bit element 110 at the end of quantum annealing for each quantum annealing time in the case of Γ=1.0.

FIG. 12 is a diagram illustrating an example of variance of position operators of a quantum state of the second quantum bit element 110 in Case 2 by the first control method.

The horizontal axis of the graph of FIG. 12 indicates the quantum annealing time. The vertical axis indicates the variance √(<x²>−<x>²) of the position operator x of the quantum state of the second quantum bit element 110 at the end of quantum annealing.

A line L281 indicates the variance of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L281 is illustrated for comparison with cases where an estimated solution is set as the initial state of the quantum bit element 110, indicated by lines L282 to L286.

The line L282 indicates the variance of the position operator of the quantum state of the second quantum bit element 110 at the end of quantum annealing for each quantum annealing time in the case of Γ=0.2.

The line L283 indicates the variance of the position operator of the quantum state of the second quantum bit element 110 at the end of quantum annealing for each quantum annealing time in the case of Γ=0.4.

The line L284 indicates the variance of the position operator of the quantum state of the second quantum bit element 110 at the end of quantum annealing for each quantum annealing time in the case of Γ=0.6.

The line L285 indicates the variance of the position operator of the quantum state of the second quantum bit element 110 at the end of quantum annealing for each quantum annealing time in the case of Γ=0.8.

The line L286 indicates the variance of the position operator of the quantum state of the second quantum bit element 110 at the end of quantum annealing for each quantum annealing time in the case of Γ=1.0.

(First Control Method, Case 3 (ε₁=−1, ε₂+1))

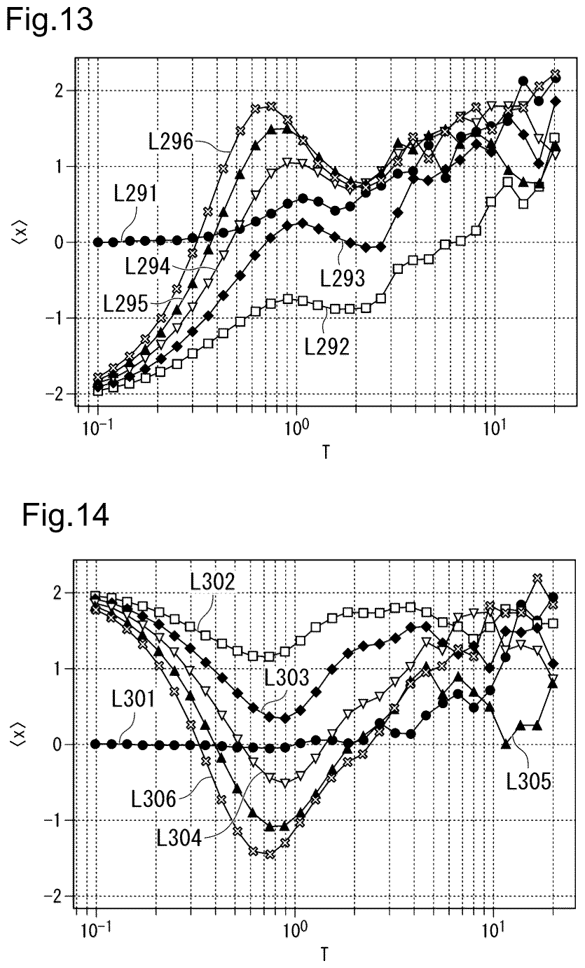

FIG. 13 is a diagram illustrating an example of an expected value of a position operator of a quantum state of the first quantum bit element 110 in Case 3 by the first control method.

The horizontal axis of the graph of FIG. 13 indicates the quantum annealing time. The vertical axis indicates the expected value <x> of the position operator x of the quantum state of the first quantum bit element 110 at the end of quantum annealing.

A line L291 indicates the expected value of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L291 is illustrated for comparison with cases where an estimated solution is set as the initial state of the quantum bit element 110, indicated by lines L292 to L296.

The line L292 indicates the expected value of the position operator of the quantum state of the first quantum bit element 110 at the end of quantum annealing for each quantum annealing time in the case of Γ=0.2.

The line L293 indicates the expected value of the position operator of the quantum state of the first quantum bit element 110 at the end of quantum annealing for each quantum annealing time in the case of Γ=0.4.

The line L294 indicates the expected value of the position operator of the quantum state of the first quantum bit element 110 at the end of quantum annealing for each quantum annealing time in the case of Γ=0.6.

The line L295 indicates the expected value of the position operator of the quantum state of the first quantum bit element 110 at the end of quantum annealing for each quantum annealing time in the case of Γ=0.8.

The line L296 indicates the expected value of the position operator of the quantum state of the first quantum bit element 110 at the end of quantum annealing for each quantum annealing time in the case of Γ=1.0.

FIG. 14 is a diagram illustrating an example of an expected value of a position operator of a quantum state of the second quantum bit element 110 in Case 3 by the first control method.

The horizontal axis of the graph of FIG. 14 indicates the quantum annealing time. The vertical axis indicates the expected value <x> of the position operator x of the quantum state of the second quantum bit element 110 at the end of quantum annealing.

A line L301 indicates the expected value of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L301 is illustrated for comparison with cases where an estimated solution is set as the initial state of the quantum bit element 110, indicated by lines L302 to L306.

The line L302 indicates the expected value of the position operator of the quantum state of the second quantum bit element 110 at the end of quantum annealing for each quantum annealing time in the case of Γ=0.2.

The line L303 indicates the expected value of the position operator of the quantum state of the second quantum bit element 110 at the end of quantum annealing for each quantum annealing time in the case of Γ=0.4.

The line L304 indicates the expected value of the position operator of the quantum state of the second quantum bit element 110 at the end of quantum annealing for each quantum annealing time in the case of Γ=0.6.

The line L305 indicates the expected value of the position operator of the quantum state of the second quantum bit element 110 at the end of quantum annealing for each quantum annealing time in the case of Γ=0.8.

The line L306 indicates the expected value of the position operator of the quantum state of the second quantum bit element 110 at the end of quantum annealing for each quantum annealing time in the case of Γ=1.0.

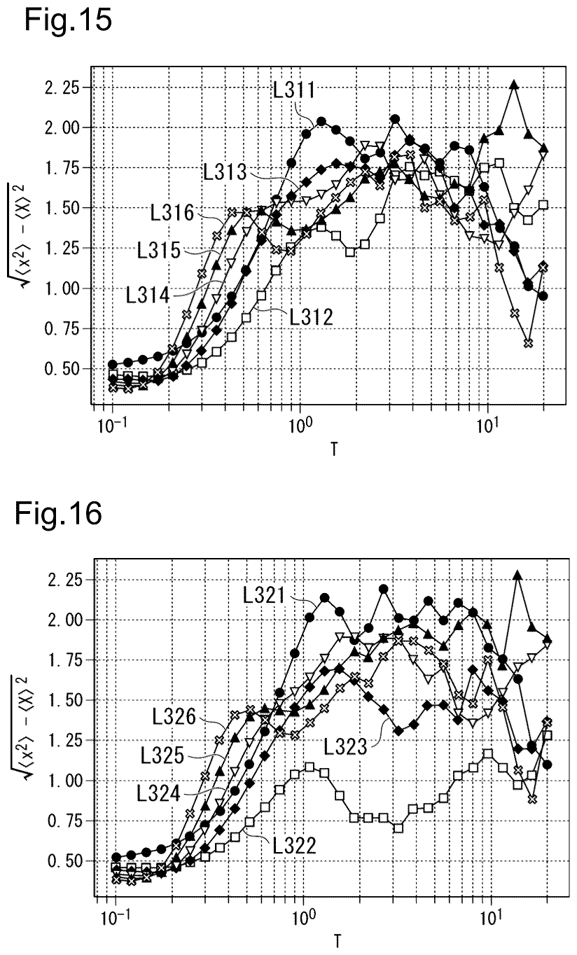

FIG. 15 is a diagram illustrating an example of variance of position operators of a quantum state of the first quantum bit element 110 in Case 3 by the first control method.

The horizontal axis of the graph of FIG. 15 indicates the quantum annealing time. The vertical axis indicates the variance √(<x²>−<x>²) of the position operator x of the quantum state of the first quantum bit element 110 at the end of quantum annealing.

A line L311 indicates the variance of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L311 is illustrated for comparison with cases where an estimated solution is set as the initial state of the quantum bit element 110, indicated by lines L312 to L316.

The line L312 indicates the variance of the position operator of the quantum state of the first quantum bit element 110 at the end of quantum annealing for each quantum annealing time in the case of Γ=0.2.

The line L313 indicates the variance of the position operator of the quantum state of the first quantum bit element 110 at the end of quantum annealing for each quantum annealing time in the case of Γ=0.4.

The line L314 indicates the variance of the position operator of the quantum state of the first quantum bit element 110 at the end of quantum annealing for each quantum annealing time in the case of Γ=0.6.

The line L315 indicates the variance of the position operator of the quantum state of the first quantum bit element 110 at the end of quantum annealing for each quantum annealing time in the case of Γ=0.8.

The line L316 indicates the variance of the position operator of the quantum state of the first quantum bit element 110 at the end of quantum annealing for each quantum annealing time in the case of Γ=1.0.

FIG. 16 is a diagram illustrating an example of variance of position operators of a quantum state of the second quantum bit element 110 in Case 3 by the first control method.

The horizontal axis of the graph of FIG. 16 indicates the quantum annealing time. The vertical axis indicates the variance √(<x²>−<x>²) of the position operator x of the quantum state of the second quantum bit element 110 at the end of quantum annealing.

A line L321 indicates the variance of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L321 is illustrated for comparison with cases where an estimated solution is set as the initial state of the quantum bit element 110, indicated by lines L322 to L326.

The line L322 indicates the variance of the position operator of the quantum state of the second quantum bit element 110 at the end of quantum annealing for each quantum annealing time in the case of Γ=0.2.

The line L323 indicates the variance of the position operator of the quantum state of the second quantum bit element 110 at the end of quantum annealing for each quantum annealing time in the case of Γ=0.4.

The line L324 indicates the variance of the position operator of the quantum state of the second quantum bit element 110 at the end of quantum annealing for each quantum annealing time in the case of Γ=0.6.

The line L325 indicates the variance of the position operator of the quantum state of the second quantum bit element 110 at the end of quantum annealing for each quantum annealing time in the case of Γ=0.8.

The line L326 indicates the variance of the position operator of the quantum state of the second quantum bit element 110 at the end of quantum annealing for each quantum annealing time in the case of Γ=1.0.

(First Control Method, Case 4 (ε₁=−1, ε₂=−1))

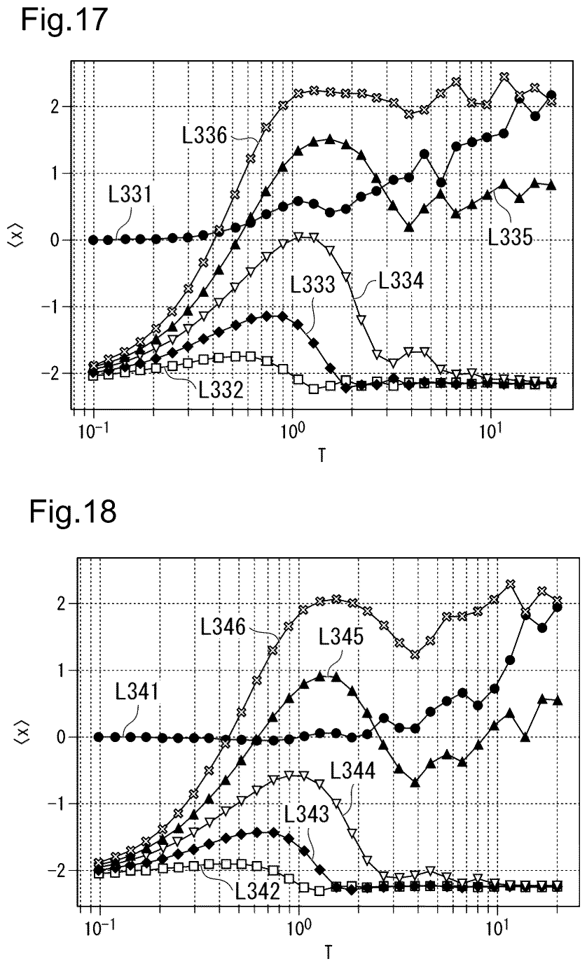

FIG. 17 is a diagram illustrating an example of an expected value of a position operator of a quantum state of the first quantum bit element 110 in Case 4 by the first control method.

The horizontal axis of the graph of FIG. 17 indicates the quantum annealing time. The vertical axis indicates the expected value <x> of the position operator x of the quantum state of the first quantum bit element 110 at the end of quantum annealing.

A line L331 indicates the expected value of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L331 is illustrated for comparison with cases where an estimated solution is set as the initial state of the quantum bit element 110, indicated by lines L332 to L336.

The line L332 indicates the expected value of the position operator of the quantum state of the first quantum bit element 110 at the end of quantum annealing for each quantum annealing time in the case of Γ=0.2.

The line L333 indicates the expected value of the position operator of the quantum state of the first quantum bit element 110 at the end of quantum annealing for each quantum annealing time in the case of Γ=0.4.

The line L334 indicates the expected value of the position operator of the quantum state of the first quantum bit element 110 at the end of quantum annealing for each quantum annealing time in the case of Γ=0.6.

The line L335 indicates the expected value of the position operator of the quantum state of the first quantum bit element 110 at the end of quantum annealing for each quantum annealing time in the case of Γ=0.8.

The line L336 indicates the expected value of the position operator of the quantum state of the first quantum bit element 110 at the end of quantum annealing for each quantum annealing time in the case of Γ=1.0.

FIG. 18 is a diagram illustrating an example of an expected value of a position operator of a quantum state of the second quantum bit element 110 in Case 4 by the first control method.

The horizontal axis of the graph of FIG. 18 indicates the quantum annealing time. The vertical axis indicates the expected value <x> of the position operator x of the quantum state of the second quantum bit element 110 at the end of quantum annealing.

A line L341 indicates the expected value of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L341 is illustrated for comparison with cases where an estimated solution is set as the initial state of the quantum bit element 110, indicated by lines L342 to L346.

The line L342 indicates the expected value of the position operator of the quantum state of the second quantum bit element 110 at the end of quantum annealing for each quantum annealing time in the case of Γ=0.2.

The line L343 indicates the expected value of the position operator of the quantum state of the second quantum bit element 110 at the end of quantum annealing for each quantum annealing time in the case of Γ=0.4.

The line L344 indicates the expected value of the position operator of the quantum state of the second quantum bit element 110 at the end of quantum annealing for each quantum annealing time in the case of Γ=0.6.

The line L345 indicates the expected value of the position operator of the quantum state of the second quantum bit element 110 at the end of quantum annealing for each quantum annealing time in the case of Γ=0.8.

The line L346 indicates the expected value of the position operator of the quantum state of the second quantum bit element 110 at the end of quantum annealing for each quantum annealing time in the case of Γ=1.0.

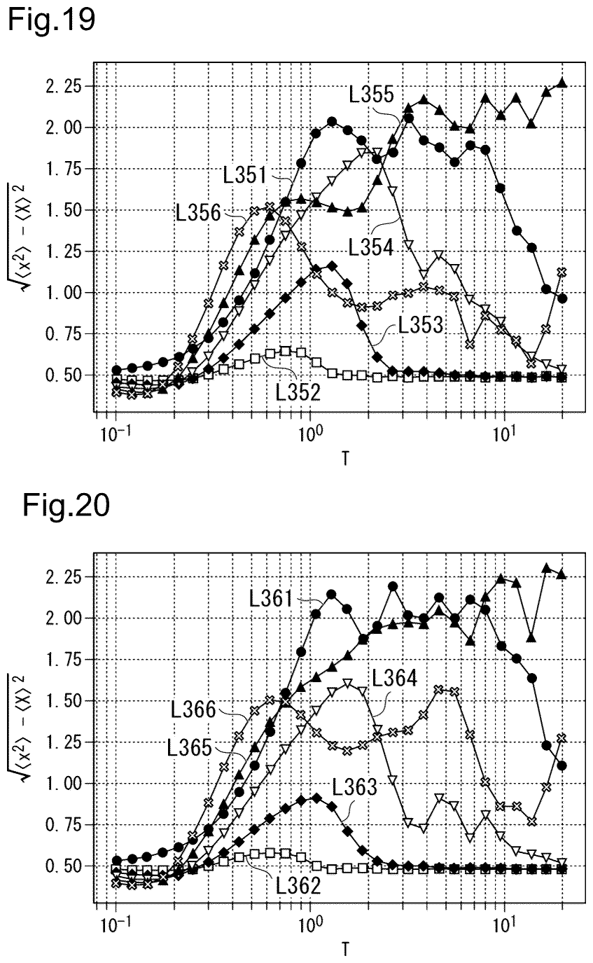

FIG. 19 is a diagram illustrating an example of variance of position operators of a quantum state of the first quantum bit element 110 in Case 4 by the first control method.

The horizontal axis of the graph of FIG. 19 indicates the quantum annealing time. The vertical axis indicates the variance √(<x²>−<x>²) of the position operator x of the quantum state of the first quantum bit element 110 at the end of quantum annealing.

A line L351 indicates the variance of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L351 is illustrated for comparison with cases where an estimated solution is set as the initial state of the quantum bit element 110, indicated by lines L352 to L356.

The line L352 indicates the variance of the position operator of the quantum state of the first quantum bit element 110 at the end of quantum annealing for each quantum annealing time in the case of Γ=0.2.

The line L353 indicates the variance of the position operator of the quantum state of the first quantum bit element 110 at the end of quantum annealing for each quantum annealing time in the case of Γ=0.4.

The line L354 indicates the variance of the position operator of the quantum state of the first quantum bit element 110 at the end of quantum annealing for each quantum annealing time in the case of Γ=0.6.

The line L355 indicates the variance of the position operator of the quantum state of the first quantum bit element 110 at the end of quantum annealing for each quantum annealing time in the case of Γ=0.8.

The line L356 indicates the variance of the position operator of the quantum state of the first quantum bit element 110 at the end of quantum annealing for each quantum annealing time in the case of Γ=1.0.

FIG. 20 is a diagram illustrating an example of variance of position operators of a quantum state of the second quantum bit element 110 in Case 4 by the first control method.

The horizontal axis of the graph of FIG. 20 indicates the quantum annealing time. The vertical axis indicates the variance √(<x²>−<x>²) of the position operator x of the quantum state of the second quantum bit element 110 at the end of quantum annealing.

A line L361 indicates the variance of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L361 is illustrated for comparison with cases where an estimated solution is set as the initial state of the quantum bit element 110, indicated by lines L362 to L366.

The line L362 indicates the variance of the position operator of the quantum state of the second quantum bit element 110 at the end of quantum annealing for each quantum annealing time in the case of Γ=0.2.

The line L363 indicates the variance of the position operator of the quantum state of the second quantum bit element 110 at the end of quantum annealing for each quantum annealing time in the case of Γ=0.4.

The line L364 indicates the variance of the position operator of the quantum state of the second quantum bit element 110 at the end of quantum annealing for each quantum annealing time in the case of Γ=0.6.

The line L365 indicates the variance of the position operator of the quantum state of the second quantum bit element 110 at the end of quantum annealing for each quantum annealing time in the case of Γ=0.8.

The line L366 indicates the variance of the position operator of the quantum state of the second quantum bit element 110 at the end of quantum annealing for each quantum annealing time in the case of Γ=1.0.

In the experiment, the optimal solution is obtained when the values of the two quantum bits are both +1. Therefore, in the examples of FIGS. 5 to 20, in both the first quantum bit element 110 and the second quantum bit element 110, as the expected value of the position operator at the end of quantum annealing is large (positive value and magnitude is large) and the variance is small, it can be regarded that the optimal solution is easily obtained. In particular, in a case where the expected value of the position operator at the end of the quantum annealing is larger and the variance is smaller than those in a case where the quantum annealing is performed with the initial state as the vacuum state, it is expected that the possibility of obtaining the optimal solution becomes higher by setting the estimated solution as the initial value of the quantum bit element 110.

Referring to the experimental result (simulation result) for each case, in Case 1 (ε₁=+1, ε₂=+1), in any of Γ=0.2, Γ=0.4, and Γ=0.6, the expected value is larger and the variance is smaller than those when the initial state is the vacuum state.

In the case of Γ=0.8, when approximately T≤3×10⁻¹ and approximately T≥1.5×10⁰, the expected value is larger and the variance is smaller than when the initial state is the vacuum state.

In the case of Γ=1.0, when approximately T≤2.5×10⁻¹ and approximately T≥4×10⁰, the expected value is larger and the variance is smaller than when the initial state is the vacuum state.

In Case 2 (ε₁=+1, ε₂=−1), in the case of Γ=0.8, when approximately T≥4×10⁰, the expected value is larger and the variance is smaller than those when the initial state is the vacuum state.

In the case of Γ=1.0, when approximately T≥2×10⁰, the expected value is larger and the variance is smaller than when the initial state is the vacuum state.

In Case 3 (ε₁=−1, ε₂=+1), in the case of Γ=0.6, when approximately 3×10⁰≤T≤1×10¹, the expected value is larger and the variance is smaller than those when the initial state is the vacuum state.

In the case of Γ=0.8, when approximately 3×10⁰≤T≤8×10⁰, the expected value is larger and the variance is smaller than those when the initial state is the vacuum state.

In the case of Γ=1.0, when approximately 3×10⁰≤T≤1×10¹, the expected value is larger and the variance is smaller than those when the initial state is the vacuum state.

In Case 4 (ε₁=−1, ε₂=−1), in the case of Γ=0.8, when approximately 7×10⁻¹≤T≤2×10⁰, the expected value is larger and the variance is smaller than those when the initial state is the vacuum state.

In the case of Γ=1.0, when approximately 7×10⁻¹≤T≤1×10¹, the expected value is larger and the variance is smaller than those when the initial state is the vacuum state.

According to the experimental results, for example, in the case of the Hamiltonian shown in Formula (2), when Γ=0.8 and 4×10⁰≤T≤2×10⁰, it is expected that there is a higher possibility of obtaining an optimal solution than when the initial state is the vacuum state. When Γ=1.0 and 4×10⁰≤T≤1×10¹, it is expected that there is a higher possibility of obtaining an optimal solution than when the initial state is a vacuum state.

Consequently, it can be regarded that a desired solution is expected to be obtained in a shorter time when Γ=0.8 or Γ=1.0 than when the initial state is the vacuum state.

Alternatively, the information processing device 1 may repeatedly perform quantum annealing while changing the setting of the constant Γ and the quantum annealing time T.

Furthermore, the information processing device 1 may repeatedly perform quantum annealing while changing the estimated solution set as the initial value of the quantum bit element 110 in addition to the setting of the constant Γ and the quantum annealing time T.

### (Second Control Method)

As an example of the second control method, an experiment by simulation was performed for a case of using the Hamiltonian H shown in Formula (3).

$$\begin{matrix}[ Math . 3 ] & \\ H = {\sum }_{i = 1}^{2} [ Γ sin ( \frac{π t}{T} ) {a}_{i}^{†} {a}_{i} + \frac{K}{2} {( {a}_{i}^{†} )}^{2} {( {a}_{i} )}^{2} - \frac{{p}_{1}}{2} \frac{t}{T} ( {( {a}_{i}^{†} )}^{2} + {( {a}_{i} )}^{2} ) - ( 1 - \frac{t}{T} ) \frac{{ε}_{i}}{2} ( {a}_{i}^{†} + {a}_{i} ) ] + \frac{t}{T} [ - ( {a}_{1}^{†} {a}_{2} + {a}_{1} {a}_{2}^{†} ) - ( {a}_{1}^{†} + {a}_{1} ) ] & ( 3 )\end{matrix}$$

When Formula (3) is compared with Formula (2), the setting of the pump strength p (t) of Formula (1) is different. In Formula (2), p (t)=p₁ (1−Γ sin (π/T)), whereas in formula (3), p (t)=(p₁/2) (t/T). In other respects, Formula (3) is similar to Formula (2).

Also in the experiment of the second control method, the Kerr nonlinearity K was set to 1, and the initial value P₁ of the pump strength was set to 4.

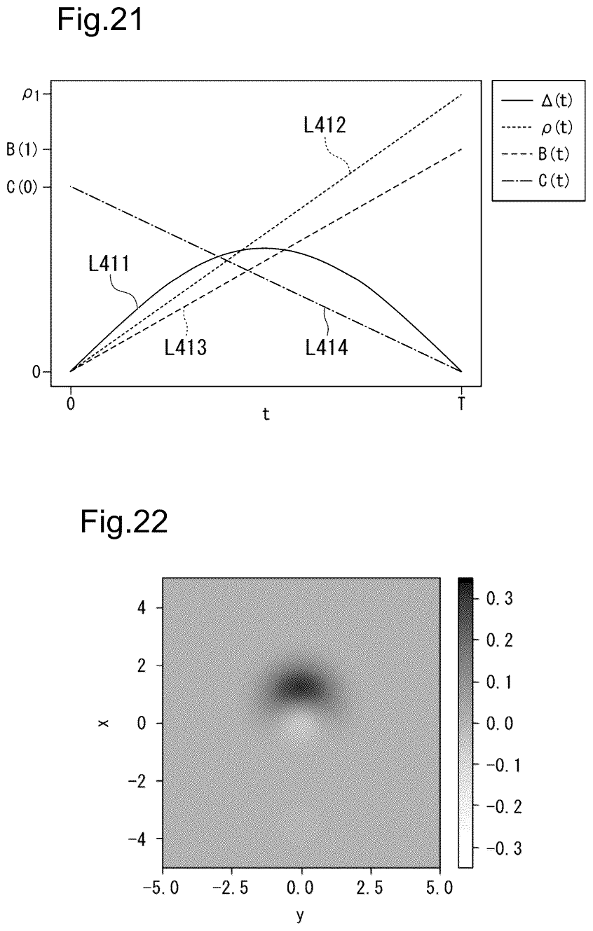

FIG. 21 is a diagram illustrating an example of a temporal change of a value of each parameter in the second control method.

FIG. 21 illustrates an example of the temporal change of a value of each parameter in a case where the Hamiltonian illustrated in Formula (3) is used.

The horizontal axis of the graph in FIG. 21 indicates the time in one quantum annealing. As described above, time 0 indicates the start of quantum annealing. Time T indicates the end of quantum annealing.

The vertical axis of the graph of FIG. 21 indicates the value of the parameter.

Lines L411, L413, and L414 are similar to those in FIG. 2. The line L411 indicates the detuning Δ (t) for each time t. A line L413 indicates the value of the coefficient B (t) of the term of the Hamiltonian indicating the optimization problem to be solved for each time t. The line L414 indicates the value of the coefficient C (t) of the term of the Hamiltonian for initialization of the quantum bit element 110 for each time t.

A line L412 indicates the pump strength p (t) for each time t. In the example of FIG. 21, the control unit 200 increases the pump strength p (t) from the initial value 0 to the final value p₁.

FIG. 22 is a diagram illustrating a first example of the initial state of the quantum bit element 110 in the second control method. FIG. 22 illustrates a plot of a Wigner function in a case where the initial state of the i-th quantum bit element 110 is set to εᵢ=+1.

The horizontal axis (y coordinate) of the graph of FIG. 22 indicates the expected value <p> for the momentum operator p of the quantum state of the quantum bit element 110. The vertical axis (x coordinate) indicates the expected value <x> for the position operator x of the quantum state of the quantum bit element 110.

In the example of FIG. 22, function values are plotted near the x>0 side and around x=0. In the initial setting of the parameter value illustrated in FIG. 21, the detuning and the pump strength are set to be small values (e.g., 0), and the value of the coefficient C (t) is sufficiently increased with respect to the value of the coefficient B (t), so that the state of εᵢ=+1 can be regarded as being relatively weakly (weaker than case of first control method) reflected as the initial state of the quantum bit element 110.

The example of FIG. 22 corresponds to an example in which the quantum state of the quantum bit element 110 is initialized in such a way as to indicate a value of +1 out of +1 and −1, which are binary values of the quantum bits.

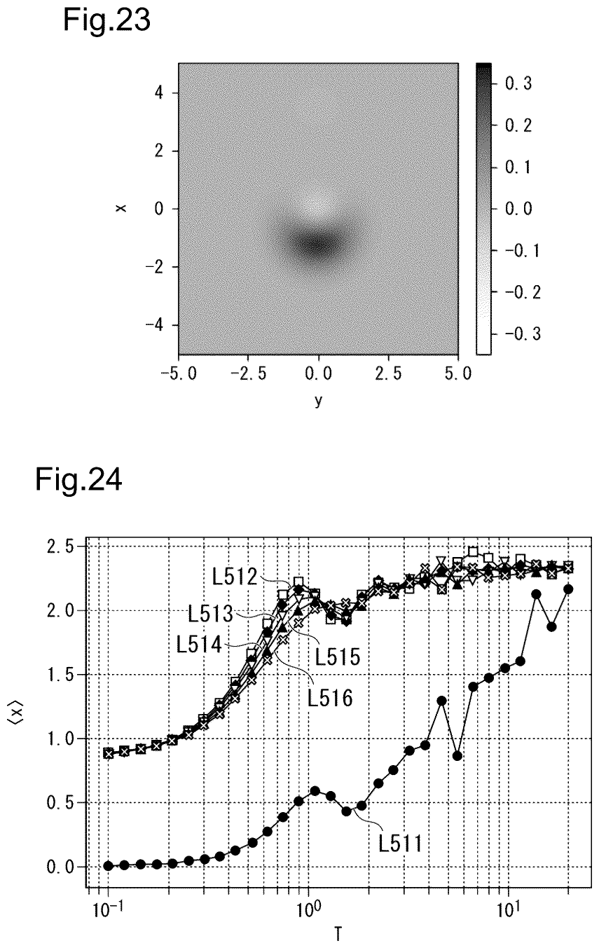

FIG. 23 is a diagram illustrating a second example of the initial state of the quantum bit element 110 in the second control method. FIG. 23 illustrates a plot of a Wigner function in a case where the initial state of the i-th quantum bit element 110 is set to εᵢ=−1.

The horizontal axis (y coordinate) of the graph of FIG. 23 indicates the expected value <p> for the momentum operator p of the quantum state of the quantum bit element 110. The vertical axis (x coordinate) indicates the expected value <x> for the position operator x of the quantum state of the quantum bit element 110.

In the example of FIG. 23, function values are plotted near the x<0 side and around x=0. In the initial setting of the parameter value illustrated in FIG. 21, the detuning and the pump strength are set to be small values (e.g., 0), and the value of the coefficient C (t) is sufficiently increased with respect to the value of the coefficient B (t), so that the state of εᵢ=−1 can be regarded as being relatively weakly (weaker than case of first control method) reflected as the initial state of the quantum bit element 110.

The example of FIG. 23 corresponds to an example in which the quantum state of the quantum bit element 110 is initialized in such a way as to indicate a value of −1 out of +1 and −1, which are binary values of the quantum bits.

Also in the second control method, for each of Cases 1 to 4 described above, the value of the constant Γ in Formula (3) was variously set, and quantum annealing was performed for different quantum annealing times to calculate the expected value and variance of the position operator of the quantum state of the quantum bit element 110.

(Second Control Method, Case 1 (ε₁=+1, ε₂=+1))

FIG. 24 is a diagram illustrating an example of an expected value of a position operator of a quantum state of the first quantum bit element 110 in Case 1 by the second control method.

The horizontal axis of the graph of FIG. 24 indicates the quantum annealing time. The vertical axis indicates the expected value <x> of the position operator x of the quantum state of the first quantum bit element 110 at the end of quantum annealing.

A line L511 indicates the expected value of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L511 is illustrated for comparison with cases where an estimated solution is set as the initial state of the quantum bit element 110, indicated by lines L512 to L516.

The line L512 indicates the expected value of the position operator of the quantum state of the first quantum bit element 110 at the end of quantum annealing for each quantum annealing time in the case of Γ=0.2.

The line L513 indicates the expected value of the position operator of the quantum state of the first quantum bit element 110 at the end of quantum annealing for each quantum annealing time in the case of Γ=0.4.

The line L514 indicates the expected value of the position operator of the quantum state of the first quantum bit element 110 at the end of quantum annealing for each quantum annealing time in the case of Γ=0.6.

The line L515 indicates the expected value of the position operator of the quantum state of the first quantum bit element 110 at the end of quantum annealing for each quantum annealing time in the case of Γ=0.8.

The line L516 indicates the expected value of the position operator of the quantum state of the first quantum bit element 110 at the end of quantum annealing for each quantum annealing time in the case of Γ=1.0.

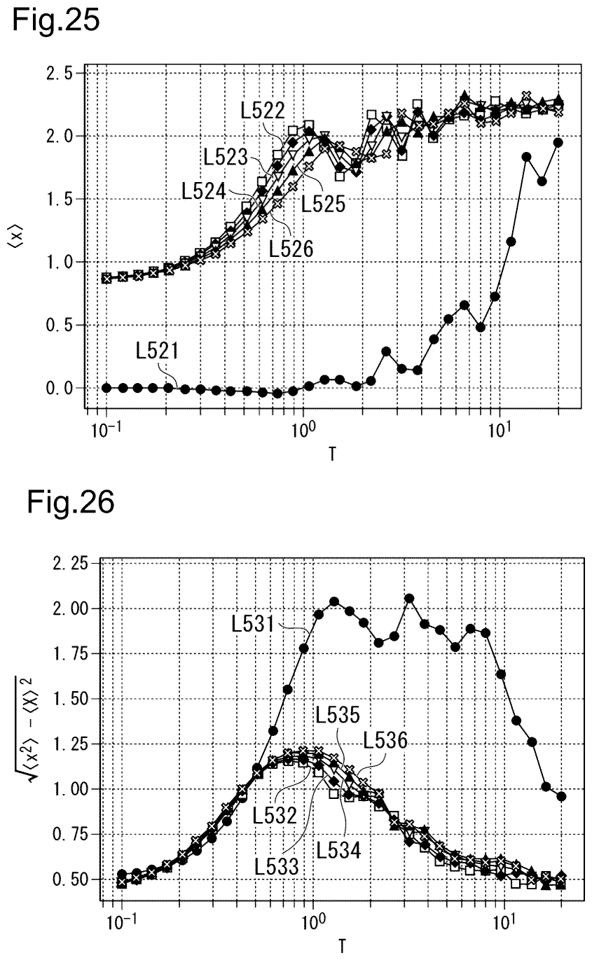

FIG. 25 is a diagram illustrating an example of an expected value of a position operator of a quantum state of the second quantum bit element 110 in Case 1 by the second control method.

The horizontal axis of the graph of FIG. 25 indicates the quantum annealing time. The vertical axis indicates the expected value <x> of the position operator x of the quantum state of the second quantum bit element 110 at the end of quantum annealing.

A line L521 indicates the expected value of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L521 is illustrated for comparison with cases where an estimated solution is set as the initial state of the quantum bit element 110, indicated by lines L522 to L526.

The line L522 indicates the expected value of the position operator of the quantum state of the second quantum bit element 110 at the end of quantum annealing for each quantum annealing time in the case of Γ=0.2.

The line L523 indicates the expected value of the position operator of the quantum state of the second quantum bit element 110 at the end of quantum annealing for each quantum annealing time in the case of Γ=0.4.

The line L524 indicates the expected value of the position operator of the quantum state of the second quantum bit element 110 at the end of quantum annealing for each quantum annealing time in the case of Γ=0.6.

The line L525 indicates the expected value of the position operator of the quantum state of the second quantum bit element 110 at the end of quantum annealing for each quantum annealing time in the case of Γ=0.8.

The line L526 indicates the expected value of the position operator of the quantum state of the second quantum bit element 110 at the end of quantum annealing for each quantum annealing time in the case of Γ=1.0.

FIG. 26 is a diagram illustrating an example of variance of position operators of a quantum state of the first quantum bit element 110 in Case 1 by the second control method.

The horizontal axis of the graph of FIG. 26 indicates the quantum annealing time. The vertical axis indicates the variance √(<x²>−<x>²) of the position operator x of the quantum state of the first quantum bit element 110 at the end of quantum annealing.

A line L531 indicates the variance of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L531 is illustrated for comparison with cases where an estimated solution is set as the initial state of the quantum bit element 110, indicated by lines L532 to L536.

The line L532 indicates the variance of the position operator of the quantum state of the first quantum bit element 110 at the end of quantum annealing for each quantum annealing time in the case of Γ=0.2.

The line L533 indicates the variance of the position operator of the quantum state of the first quantum bit element 110 at the end of quantum annealing for each quantum annealing time in the case of Γ=0.4.

The line L534 indicates the variance of the position operator of the quantum state of the first quantum bit element 110 at the end of quantum annealing for each quantum annealing time in the case of Γ=0.6.

The line L535 indicates the variance of the position operator of the quantum state of the first quantum bit element 110 at the end of quantum annealing for each quantum annealing time in the case of Γ=0.8.

The line L536 indicates the variance of the position operator of the quantum state of the first quantum bit element 110 at the end of quantum annealing for each quantum annealing time in the case of Γ=1.0.

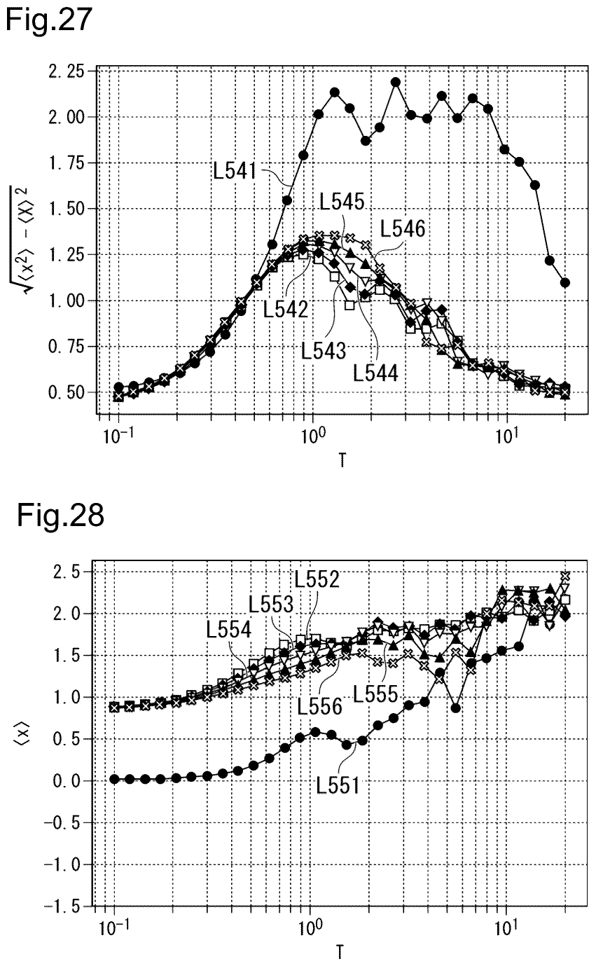

FIG. 27 is a diagram illustrating an example of variance of position operators of a quantum state of the second quantum bit element 110 in Case 1 by the second control method.

The horizontal axis of the graph of FIG. 27 indicates the quantum annealing time. The vertical axis indicates the variance √(<x²>−<x>²) of the position operator x of the quantum state of the second quantum bit element 110 at the end of quantum annealing.

A line L541 indicates the variance of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L541 is illustrated for comparison with cases where an estimated solution is set as the initial state of the quantum bit element 110, indicated by lines L542 to L546.

The line L542 indicates the variance of the position operator of the quantum state of the second quantum bit element 110 at the end of quantum annealing for each quantum annealing time in the case of Γ=0.2.

The line L543 indicates the variance of the position operator of the quantum state of the second quantum bit element 110 at the end of quantum annealing for each quantum annealing time in the case of Γ=0.4.

The line L544 indicates the variance of the position operator of the quantum state of the second quantum bit element 110 at the end of quantum annealing for each quantum annealing time in the case of Γ=0.6.

The line L545 indicates the variance of the position operator of the quantum state of the second quantum bit element 110 at the end of quantum annealing for each quantum annealing time in the case of Γ=0.8.

The line L546 indicates the variance of the position operator of the quantum state of the second quantum bit element 110 at the end of quantum annealing for each quantum annealing time in the case of Γ=1.0.

(Second Control Method, Case 2 (ε₁=+1, ε₂=−1))

FIG. 28 is a diagram illustrating an example of an expected value of a position operator of a quantum state of the first quantum bit element 110 in Case 2 by the second control method.

The horizontal axis of the graph of FIG. 28 indicates the quantum annealing time. The vertical axis indicates the expected value <x> of the position operator x of the quantum state of the first quantum bit element 110 at the end of quantum annealing.

A line L551 indicates the expected value of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L551 is illustrated for comparison with cases where an estimated solution is set as the initial state of the quantum bit element 110, indicated by lines L552 to L556.

The line L552 indicates the expected value of the position operator of the quantum state of the first quantum bit element 110 at the end of quantum annealing for each quantum annealing time in the case of Γ=0.2.

The line L553 indicates the expected value of the position operator of the quantum state of the first quantum bit element 110 at the end of quantum annealing for each quantum annealing time in the case of Γ=0.4.

The line L554 indicates the expected value of the position operator of the quantum state of the first quantum bit element 110 at the end of quantum annealing for each quantum annealing time in the case of Γ=0.6.

The line L555 indicates the expected value of the position operator of the quantum state of the first quantum bit element 110 at the end of quantum annealing for each quantum annealing time in the case of Γ=0.8.

The line L556 indicates the expected value of the position operator of the quantum state of the first quantum bit element 110 at the end of quantum annealing for each quantum annealing time in the case of Γ=1.0.

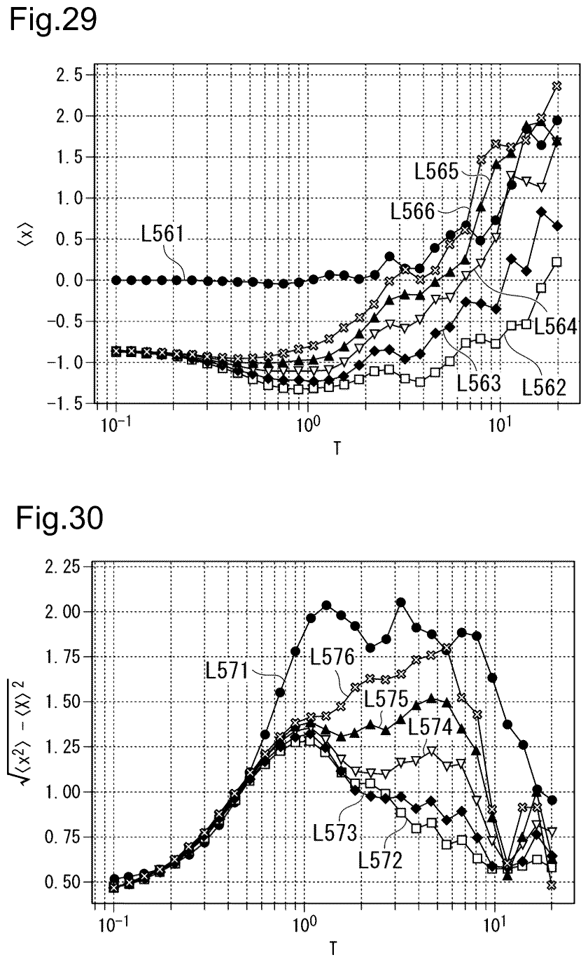

FIG. 29 is a diagram illustrating an example of an expected value of a position operator of a quantum state of the second quantum bit element 110 in Case 2 by the second control method.

The horizontal axis of the graph of FIG. 29 indicates the quantum annealing time. The vertical axis indicates the expected value <x> of the position operator x of the quantum state of the second quantum bit element 110 at the end of quantum annealing.

A line L561 indicates the expected value of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L561 is illustrated for comparison with cases where an estimated solution is set as the initial state of the quantum bit element 110, indicated by lines L562 to L566.

The line L562 indicates the expected value of the position operator of the quantum state of the second quantum bit element 110 at the end of quantum annealing for each quantum annealing time in the case of Γ=0.2.

The line L563 indicates the expected value of the position operator of the quantum state of the second quantum bit element 110 at the end of quantum annealing for each quantum annealing time in the case of Γ=0.4.

The line L564 indicates the expected value of the position operator of the quantum state of the second quantum bit element 110 at the end of quantum annealing for each quantum annealing time in the case of Γ=0.6.

The line L565 indicates the expected value of the position operator of the quantum state of the second quantum bit element 110 at the end of quantum annealing for each quantum annealing time in the case of Γ=0.8.

The line L566 indicates the expected value of the position operator of the quantum state of the second quantum bit element 110 at the end of quantum annealing for each quantum annealing time in the case of Γ=1.0.

FIG. 30 is a diagram illustrating an example of variance of position operators of a quantum state of the first quantum bit element 110 in Case 2 by the second control method.

The horizontal axis of the graph of FIG. 30 indicates the quantum annealing time. The vertical axis indicates the variance √(<x²>−<x>²) of the position operator x of the quantum state of the first quantum bit element 110 at the end of quantum annealing.

A line L571 indicates the variance of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L571 is illustrated for comparison with cases where an estimated solution is set as the initial state of the quantum bit element 110, indicated by lines L572 to L576.

The line L572 indicates the variance of the position operator of the quantum state of the first quantum bit element 110 at the end of quantum annealing for each quantum annealing time in the case of Γ=0.2.

The line L573 indicates the variance of the position operator of the quantum state of the first quantum bit element 110 at the end of quantum annealing for each quantum annealing time in the case of Γ=0.4.

The line L574 indicates the variance of the position operator of the quantum state of the first quantum bit element 110 at the end of quantum annealing for each quantum annealing time in the case of Γ=0.6.

The line L575 indicates the variance of the position operator of the quantum state of the first quantum bit element 110 at the end of quantum annealing for each quantum annealing time in the case of Γ=0.8.

The line L576 indicates the variance of the position operator of the quantum state of the first quantum bit element 110 at the end of quantum annealing for each quantum annealing time in the case of Γ=1.0.

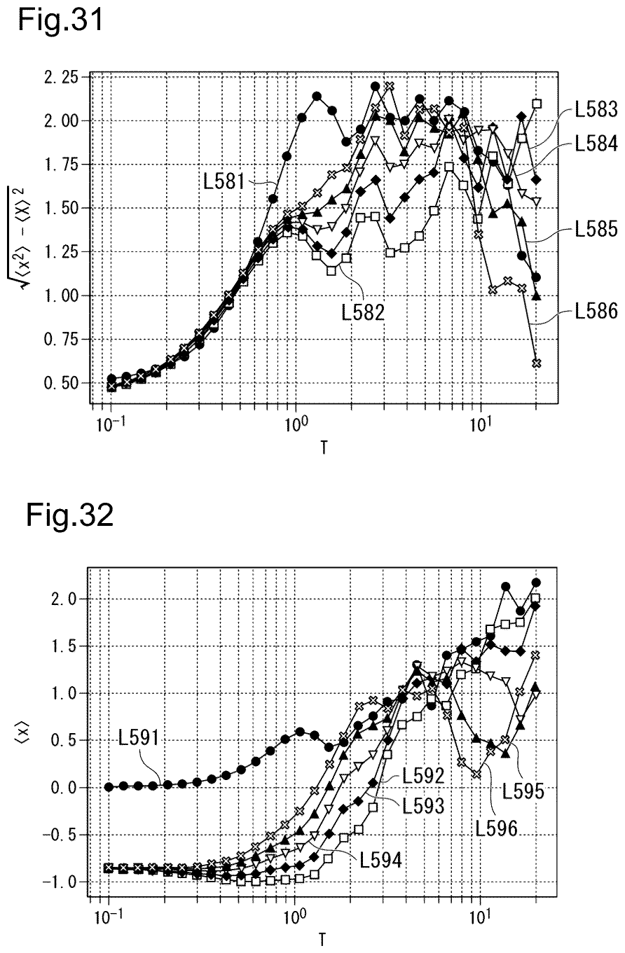

FIG. 31 is a diagram illustrating an example of variance of position operators of a quantum state of the second quantum bit element 110 in Case 2 by the second control method.

The horizontal axis of the graph of FIG. 31 indicates the quantum annealing time. The vertical axis indicates the variance √(<x²>−<x>²) of the position operator x of the quantum state of the second quantum bit element 110 at the end of quantum annealing.

A line L581 indicates the variance of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L581 is illustrated for comparison with cases where an estimated solution is set as the initial state of the quantum bit element 110, indicated by lines L582 to L586.

The line L582 indicates the variance of the position operator of the quantum state of the second quantum bit element 110 at the end of quantum annealing for each quantum annealing time in the case of Γ=0.2.

The line L583 indicates the variance of the position operator of the quantum state of the second quantum bit element 110 at the end of quantum annealing for each quantum annealing time in the case of Γ=0.4.

The line L584 indicates the variance of the position operator of the quantum state of the second quantum bit element 110 at the end of quantum annealing for each quantum annealing time in the case of Γ=0.6.

The line L585 indicates the variance of the position operator of the quantum state of the second quantum bit element 110 at the end of quantum annealing for each quantum annealing time in the case of Γ=0.8.

The line L586 indicates the variance of the position operator of the quantum state of the second quantum bit element 110 at the end of quantum annealing for each quantum annealing time in the case of Γ=1.0.

(Second Control Method, Case 3 (ε₁=−1, ε₂=+1))

FIG. 32 is a diagram illustrating an example of an expected value of a position operator of a quantum state of the first quantum bit element 110 in Case 3 by the second control method.

The horizontal axis of the graph of FIG. 32 indicates the quantum annealing time. The vertical axis indicates the expected value <x> of the position operator x of the quantum state of the first quantum bit element 110 at the end of quantum annealing.

A line L591 indicates the expected value of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L591 is illustrated for comparison with cases where an estimated solution is set as the initial state of the quantum bit element 110, indicated by lines L592 to L596.

The line L592 indicates the expected value of the position operator of the quantum state of the first quantum bit element 110 at the end of quantum annealing for each quantum annealing time in the case of Γ=0.2.

The line L593 indicates the expected value of the position operator of the quantum state of the first quantum bit element 110 at the end of quantum annealing for each quantum annealing time in the case of Γ=0.4.

The line L594 indicates the expected value of the position operator of the quantum state of the first quantum bit element 110 at the end of quantum annealing for each quantum annealing time in the case of Γ=0.6.

The line L595 indicates the expected value of the position operator of the quantum state of the first quantum bit element 110 at the end of quantum annealing for each quantum annealing time in the case of Γ=0.8.

The line L596 indicates the expected value of the position operator of the quantum state of the first quantum bit element 110 at the end of quantum annealing for each quantum annealing time in the case of Γ=1.0.

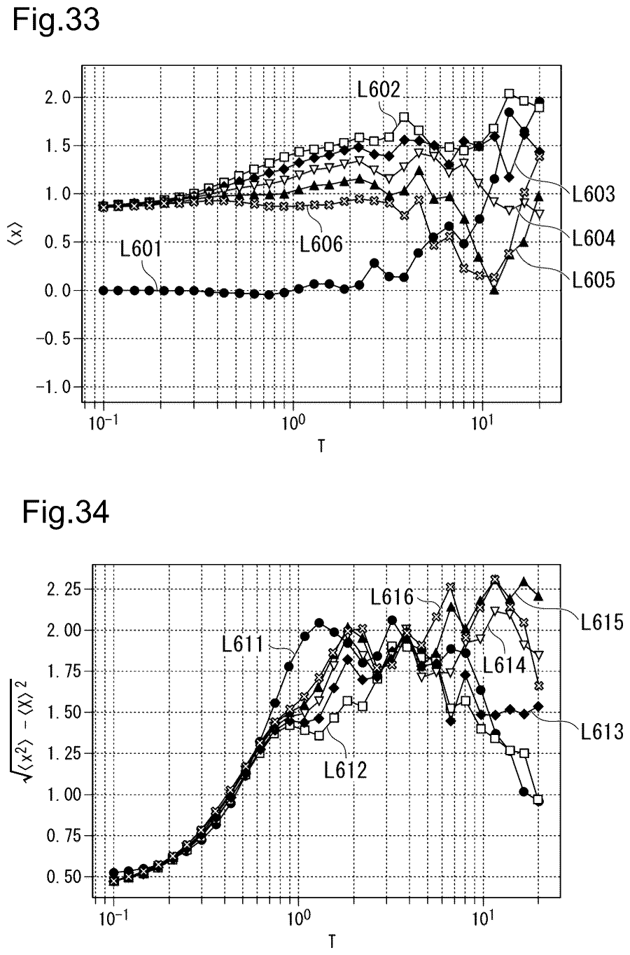

FIG. 33 is a diagram illustrating an example of an expected value of a position operator of a quantum state of the second quantum bit element 110 in Case 3 by the second control method.

The horizontal axis of the graph of FIG. 33 indicates the quantum annealing time. The vertical axis indicates the expected value <x> of the position operator x of the quantum state of the second quantum bit element 110 at the end of quantum annealing.

A line L601 indicates the expected value of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L601 is illustrated for comparison with cases where an estimated solution is set as the initial state of the quantum bit element 110, indicated by lines L602 to L606.

The line L602 indicates the expected value of the position operator of the quantum state of the second quantum bit element 110 at the end of quantum annealing for each quantum annealing time in the case of Γ=0.2.

The line L603 indicates the expected value of the position operator of the quantum state of the second quantum bit element 110 at the end of quantum annealing for each quantum annealing time in the case of Γ=0.4.

The line L604 indicates the expected value of the position operator of the quantum state of the second quantum bit element 110 at the end of quantum annealing for each quantum annealing time in the case of Γ=0.6.

The line L605 indicates the expected value of the position operator of the quantum state of the second quantum bit element 110 at the end of quantum annealing for each quantum annealing time in the case of Γ=0.8.

The line L606 indicates the expected value of the position operator of the quantum state of the second quantum bit element 110 at the end of quantum annealing for each quantum annealing time in the case of Γ=1.0.

FIG. 34 is a diagram illustrating an example of variance of position operators of a quantum state of the first quantum bit element 110 in Case 3 by the second control method.

The horizontal axis of the graph of FIG. 34 indicates the quantum annealing time. The vertical axis indicates the variance √(<x²>−<x>²) of the position operator x of the quantum state of the first quantum bit element 110 at the end of quantum annealing.

A line L611 indicates the variance of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L611 is illustrated for comparison with cases where an estimated solution is set as the initial state of the quantum bit element 110, indicated by lines L612 to L616.

The line L612 indicates the variance of the position operator of the quantum state of the first quantum bit element 110 at the end of quantum annealing for each quantum annealing time in the case of Γ=0.2.

The line L613 indicates the variance of the position operator of the quantum state of the first quantum bit element 110 at the end of quantum annealing for each quantum annealing time in the case of Γ=0.4.

The line L614 indicates the variance of the position operator of the quantum state of the first quantum bit element 110 at the end of quantum annealing for each quantum annealing time in the case of Γ=0.6.

The line L615 indicates the variance of the position operator of the quantum state of the first quantum bit element 110 at the end of quantum annealing for each quantum annealing time in the case of Γ=0.8.

The line L616 indicates the variance of the position operator of the quantum state of the first quantum bit element 110 at the end of quantum annealing for each quantum annealing time in the case of Γ=1.0.

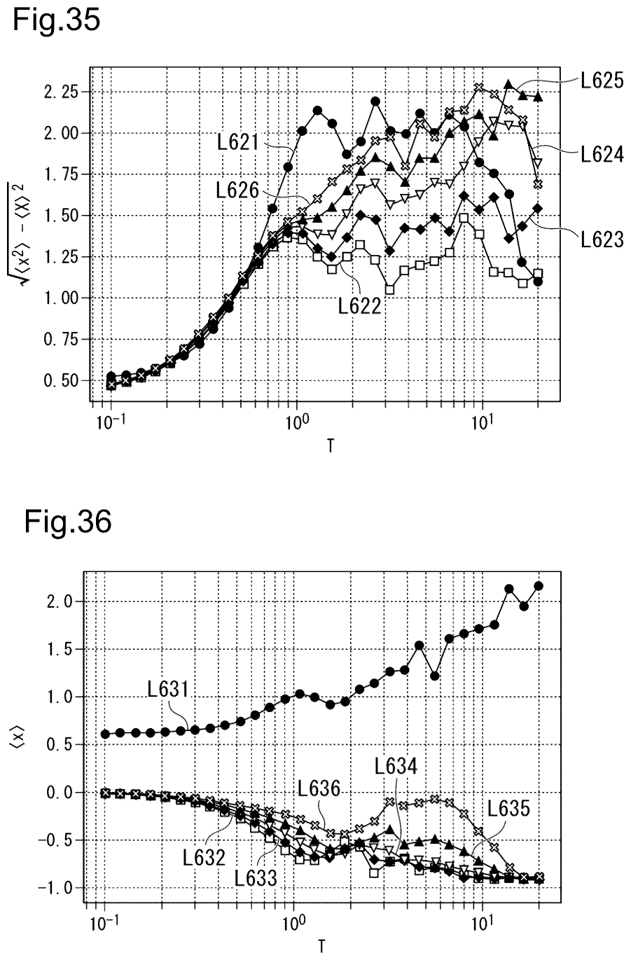

FIG. 35 is a diagram illustrating an example of variance of position operators of a quantum state of the second quantum bit element 110 in Case 3 by the second control method.

The horizontal axis of the graph of FIG. 35 indicates the quantum annealing time. The vertical axis indicates the variance √(<x²>−<x>²) of the position operator x of the quantum state of the second quantum bit element 110 at the end of quantum annealing.

A line L621 indicates the variance of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L621 is illustrated for comparison with cases where an estimated solution is set as the initial state of the quantum bit element 110, indicated by lines L622 to L626.

The line L622 indicates the variance of the position operator of the quantum state of the second quantum bit element 110 at the end of quantum annealing for each quantum annealing time in the case of Γ=0.2.

The line L623 indicates the variance of the position operator of the quantum state of the second quantum bit element 110 at the end of quantum annealing for each quantum annealing time in the case of Γ=0.4.

The line L624 indicates the variance of the position operator of the quantum state of the second quantum bit element 110 at the end of quantum annealing for each quantum annealing time in the case of Γ=0.6.

The line L625 indicates the variance of the position operator of the quantum state of the second quantum bit element 110 at the end of quantum annealing for each quantum annealing time in the case of Γ=0.8.

The line L626 indicates the variance of the position operator of the quantum state of the second quantum bit element 110 at the end of quantum annealing for each quantum annealing time in the case of Γ=1.0.

(Second control method, Case 4 (ε₁=−1, ε₂=−1))

FIG. 36 is a diagram illustrating an example of an expected value of a position operator of a quantum state of the first quantum bit element 110 in Case 4 by the second control method.

The horizontal axis of the graph of FIG. 36 indicates the quantum annealing time. The vertical axis indicates the expected value <x> of the position operator x of the quantum state of the first quantum bit element 110 at the end of quantum annealing.

A line L631 indicates the expected value of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L631 is illustrated for comparison with cases where an estimated solution is set as the initial state of the quantum bit element 110, indicated by lines L632 to L636.

The line L632 indicates the expected value of the position operator of the quantum state of the first quantum bit element 110 at the end of quantum annealing for each quantum annealing time in the case of Γ=0.2.

The line L633 indicates the expected value of the position operator of the quantum state of the first quantum bit element 110 at the end of quantum annealing for each quantum annealing time in the case of Γ=0.4.

The line L634 indicates the expected value of the position operator of the quantum state of the first quantum bit element 110 at the end of quantum annealing for each quantum annealing time in the case of Γ=0.6.

The line L635 indicates the expected value of the position operator of the quantum state of the first quantum bit element 110 at the end of quantum annealing for each quantum annealing time in the case of Γ=0.8.

The line L636 indicates the expected value of the position operator of the quantum state of the first quantum bit element 110 at the end of quantum annealing for each quantum annealing time in the case of Γ=1.0.

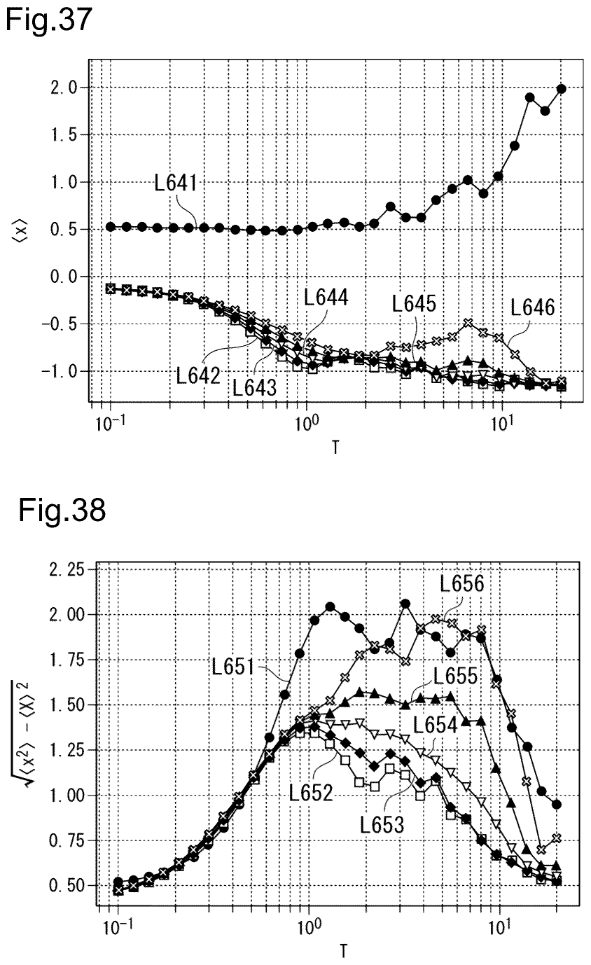

FIG. 37 is a diagram illustrating an example of an expected value of a position operator of a quantum state of the second quantum bit element 110 in Case 4 by the second control method.

The horizontal axis of the graph of FIG. 37 indicates the quantum annealing time. The vertical axis indicates the expected value <x> of the position operator x of the quantum state of the second quantum bit element 110 at the end of quantum annealing.

A line L641 indicates the expected value of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L641 is illustrated for comparison with cases where an estimated solution is set as the initial state of the quantum bit element 110, indicated by lines L642 to L646.

The line L642 indicates the expected value of the position operator of the quantum state of the second quantum bit element 110 at the end of quantum annealing for each quantum annealing time in the case of Γ=0.2.

The line L643 indicates the expected value of the position operator of the quantum state of the second quantum bit element 110 at the end of quantum annealing for each quantum annealing time in the case of Γ=0.4.

The line L644 indicates the expected value of the position operator of the quantum state of the second quantum bit element 110 at the end of quantum annealing for each quantum annealing time in the case of Γ=0.6.

The line L645 indicates the expected value of the position operator of the quantum state of the second quantum bit element 110 at the end of quantum annealing for each quantum annealing time in the case of Γ=0.8.

The line L646 indicates the expected value of the position operator of the quantum state of the second quantum bit element 110 at the end of quantum annealing for each quantum annealing time in the case of Γ=1.0.

FIG. 38 is a diagram illustrating an example of variance of position operators of a quantum state of the first quantum bit element 110 in Case 4 by the second control method.

The horizontal axis of the graph of FIG. 38 indicates the quantum annealing time. The vertical axis indicates the variance √(<x²>−<x>²) of the position operator x of the quantum state of the first quantum bit element 110 at the end of quantum annealing.

A line L651 indicates the variance of the position operator of the quantum state of the first quantum bit element 110 at the end of the quantum annealing for each quantum annealing time when the quantum annealing is performed with the initial state as the vacuum state in both the first quantum bit element 110 and the second quantum bit element 110. The line L651 is illustrated for comparison with cases where an estimated solution is set as the initial state of the quantum bit element 110, indicated by lines L652 to L656.

The line L652 indicates the variance of the position operator of the quantum state of the first quantum bit element 110 at the end of quantum annealing for each quantum annealing time in the case of Γ=0.2.

The line L653 indicates the variance of the position operator of the quantum state of the first quantum bit element 110 at the end of quantum annealing for each quantum annealing time in the case of Γ=0.4.

The line L654 indicates the variance of the position operator of the quantum state of the first quantum bit element 110 at the end of quantum annealing for each quantum annealing time in the case of Γ=0.6.

The line L655 indicates the variance of the position operator of the quantum state of the first quantum bit element 110 at the end of quantum annealing for each quantum annealing time in the case of Γ=0.8.

The line L656 indicates the variance of the position operator of the quantum state of the first quantum bit element 110 at the end of quantum annealing for each quantum annealing time in the case of Γ=1.0.

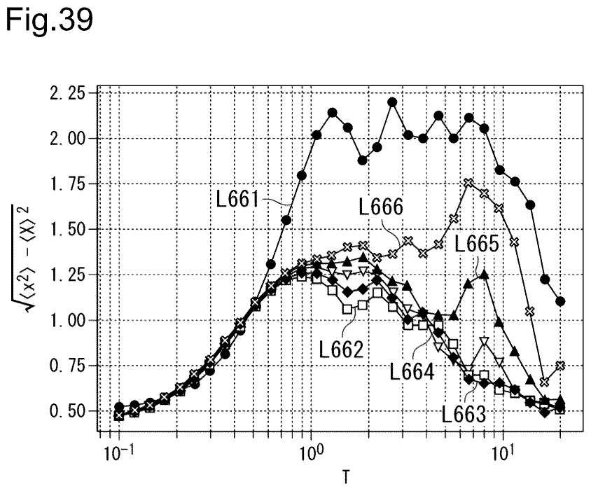

FIG. 39 is a diagram illustrating an example of variance of position operators of a quantum state of the second quantum bit element 110 in Case 4 by the second control method.

The horizontal axis of the graph of FIG. 39 indicates the quantum annealing time. The vertical axis indicates the variance √(<x²>−<x>²) of the position operator x of the quantum state of the second quantum bit element 110 at the end of quantum annealing.

A line L661 indicates the variance of the position operator of the quantum state of the second quantum bit element 110 at the end of the quantum annealing for each quantum annealing time when the quantum annealing is performed with the initial state as the vacuum state in both the first quantum bit element 110 and the second quantum bit element 110. The line L661 is illustrated for comparison with cases where an estimated solution is set as the initial state of the quantum bit element 110, indicated by lines L662 to L666.

The line L662 indicates the variance of the position operator of the quantum state of the second quantum bit element 110 at the end of quantum annealing for each quantum annealing time in the case of Γ=0.2.

The line L663 indicates the variance of the position operator of the quantum state of the second quantum bit element 110 at the end of quantum annealing for each quantum annealing time in the case of Γ=0.4.

The line L664 indicates the variance of the position operator of the quantum state of the second quantum bit element 110 at the end of quantum annealing for each quantum annealing time in the case of Γ=0.6.

The line L665 indicates the variance of the position operator of the quantum state of the second quantum bit element 110 at the end of quantum annealing for each quantum annealing time in the case of Γ=0.8.

The line L666 indicates the variance of the position operator of the quantum state of the second quantum bit element 110 at the end of quantum annealing for each quantum annealing time in the case of Γ=1.0.

Similarly to the experiment of the first control method, in the experiment of the second control method, the optimal solution is obtained when the values of the two quantum bits are both +1. Therefore, in the examples of FIGS. 24 to 39, in both the first quantum bit element 110 and the second quantum bit element 110, as the expected value of the position operator at the end of quantum annealing is large (positive value and magnitude is large) and the variance is small, it can be regarded that the optimal solution is easily obtained. In particular, in a case where the expected value of the position operator at the end of the quantum annealing is larger and the variance is smaller than those in a case where the quantum annealing is performed with the initial state as the vacuum state, it is expected that the possibility of obtaining the optimal solution becomes higher by setting the estimated solution as the initial value of the quantum bit element 110.

Referring to the experimental result (simulation result) for each case, in Case 1 (ε₁=+1, ε₂=+1), with any value of F, when approximately T≥5×10⁻¹, the expected value is larger and the variance is smaller than those when the initial state is the vacuum state.

In Case 2 (ε₁=+1, ε₂=−1), in the case of Γ=0.8, when approximately 7.5×10⁰≤T≤1.5×10¹, the expected value is larger and the variance is smaller than those when the initial state is the vacuum state.

In the case of Γ=1.0, when approximately T≥7×10⁰ and besides the vicinity of T=1.5×10¹, the expected value is larger and the variance is smaller than when the initial state is the vacuum state.

In Case 3 (ε₁=−1, ε₂=+1), for the first quantum bit element 110, at any quantum annealing time, the expected value is equal to or smaller than that when the initial state is the vacuum state, or the variance is equal to or larger than that when the initial state is the vacuum state.

In Case 4 (ε₁=−1, ε₂=−1), the expected value is smaller than that when the initial state is the vacuum state.

According to the experimental results, for example, in the case of the Hamiltonian shown in Formula (3), in Case 1 and Case 2, it may be expected that there is a higher possibility that an optimal solution can be obtained by setting the constant Γ and the quantum annealing time T than when the initial state is set to the vacuum state.

Therefore, the information processing device 1 may repeatedly perform quantum annealing while changing the setting of the constant F, the setting of the quantum annealing time T, and the estimated solution set as the initial value of the quantum bit element 110.

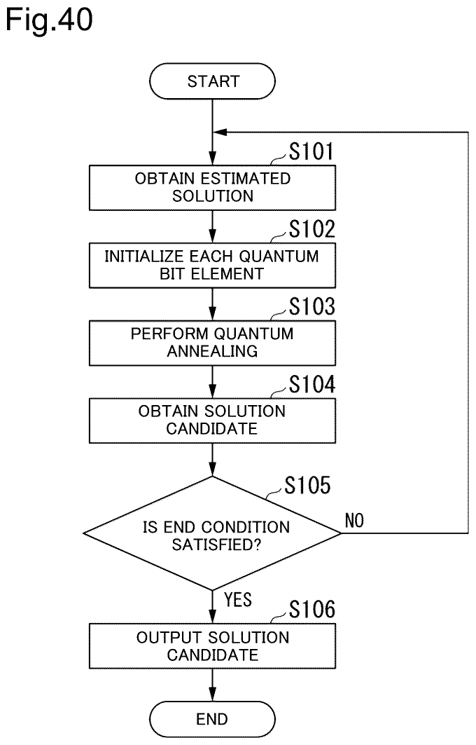

FIG. 40 is a diagram illustrating a first example of a procedure of processing performed by the information processing device 1.

In the processing of FIG. 40, the control unit 200 obtains an estimated solution set as an initial value of the quantum bit element 110 (step S101). As described above for the information processing device 1, the estimated solution set by the control unit 200 as the initial value of the quantum bit element 110 is not limited to a specific one.

Next, the control unit 200 initializes the quantum state of the quantum bit element 110 in such a way as to set the obtained estimated solution as the initial value of the quantum bit element 110 (step S102).

Next, the control unit 200 controls the quantum calculation circuit 100 to execute quantum annealing (one solution search by quantum annealing) (step S103).

Next, the observation unit 300 reads the quantum state of the quantum bit element 110 at the end of the quantum annealing to obtain solution candidates (step S104). In FIG. 40, for convenience of explanation, the estimated solution set as the initial state of the quantum bit element 110 is referred to as an “estimated solution”, and the estimated solution obtained by quantum annealing is referred to as a “solution candidate” to distinguish between the two.

Next, the control unit 200 determines whether a condition for ending repeated execution of quantum annealing is satisfied (step S105).

The end condition here is not limited to a specific condition. For example, the end condition here may be a condition that a loop from steps S101 to S105 is executed a predetermined number of times or more. Alternatively, the end condition here may be a condition that a solution candidate indicating an evaluation in which a value of an evaluation function such as a Hamiltonian indicating an optimization problem to be solved is equal to or more than a predetermined threshold is obtained.

If the control unit 200 determines that the end condition is not satisfied in step S105 (step S105: NO), the processing returns to step S101.

On the other hand, if the control unit 200 determines that the end condition is satisfied in step S105 (step S105: YES), the information processing device 1 outputs the solution candidate obtained by the quantum annealing (Step S106).

The method by which the information processing device 1 outputs the estimated solution is not limited to a specific method. For example, the information processing device 1 may have a display screen and display the estimated solution. Alternatively, the information processing device may include a communication means and transmit the estimated solution to another device.

The number of solution candidates output by the information processing device 1 is not limited to a specific number. For example, the information processing device 1 may output, from among the obtained solution candidates, a solution for which the evaluation indicated by an evaluation function value is equal to or more than a predetermined threshold. Alternatively, the information processing device 1 may output all the obtained solution candidates.

After step S106, the information processing device 1 ends the processing of FIG. 40.

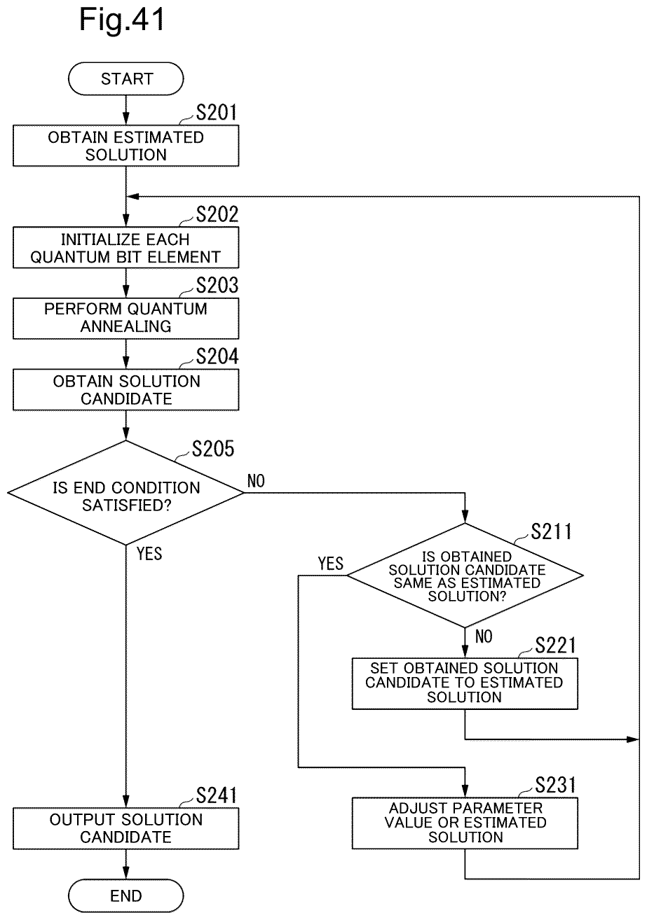

FIG. 41 is a diagram illustrating a second example of a procedure of processing performed by the information processing device 1.

Steps S201 to S205 in FIG. 41 are similar to steps S101 to S105 in FIG. 40. Also in FIG. 41, for convenience of explanation, the estimated solution set as the initial state of the quantum bit element 110 is referred to as an “estimated solution”, and the estimated solution obtained by quantum annealing is referred to as a “solution candidate” to distinguish between the two.

If it is determined in step S205 that the end condition is not satisfied (step S205: NO), the control unit 200 determines whether the obtained latest solution candidate is the same as the estimated solution set in the initial state of the quantum bit element 110 by the quantum annealing at that time (step S221).

If it is determined that the obtained solution candidate is different from the estimated solution (step S211: NO), the control unit 200 sets the obtained solution candidate as the estimated solution for setting the initial value of the quantum bit element 110 when the processing of step S202 is performed next (step S221).

After step S221, the processing returns to step S202.

On the other hand, if it is determined in step S221 that the obtained solution candidate is the same as the estimated solution (step S211: YES), the control unit 200 changes at least one of detuning, pump strength, or setting of the estimated solution (step S231). For example, the control unit 200 may change the value of the constant Γ for adjusting the detuning and the pump strength, which is exemplified in Formulae (2) and (3).

After step S231, the processing returns to step S202.

On the other hand, if the control unit 200 determines that the end condition is satisfied in Step S205 (Step S205: YES), the information processing device 1 outputs the solution candidate obtained by the quantum annealing (Step S241). Step S241 is similar to step S106 in FIG. 40.

After step S241, the information processing device 1 ends the processing of FIG. 41.

As described above, the quantum calculation circuit 100 includes the quantum bit element 110 using the parametric oscillator having the Kerr nonlinearity.

The control unit 200 initializes the quantum state of the quantum bit element 110 in such a way as to indicate any one of the binary values of the quantum bit using the coherent drive signal, and then controls the quantum calculation circuit in such a way as to increase the detuning of the quantum bit element.

According to the information processing device 1, in a case where an estimated solution (solution candidate) is obtained when a solution search is performed using a Kerr parametric oscillator, the obtained estimated solution can be reflected in the solution search. Specifically, in the information processing device 1, the quantum state of the quantum bit element 110 using the Kerr parametric oscillator is initialized in such a way as to indicate the quantum bit value in the estimated solution, and the solution search by quantum annealing can be performed. As a result, the information processing device 1 is expected to easily obtain a desired solution such as an optimal solution depending on the estimated solution set as the initial state of the quantum bit element 110.

Easily obtaining a desired solution can be regarded as obtaining a desired solution in a short time.

Here, the time required to obtain a desired solution may refer to the time required for one quantum annealing (one solution search by quantum annealing) or may refer to the time of repeated execution of quantum annealing. In a case where it is relatively easy to obtain the desired solution such as an optimal solution, it is expected that there is a relatively high possibility that the desired solution such as an optimal solution can be obtained even if the time required for one quantum annealing is relatively short, and the time required for repeatedly executing quantum annealing until the desired solution such as an optimal solution is obtained is relatively short.

After initializing the quantum state of the quantum bit element 110 using the coherent drive signal, the control unit 200 controls the quantum calculation circuit 100 in such a way that the detuning of the quantum bit element 110 is made larger and then smaller, and the amplitude of the pump signal is made smaller and then larger.

According to the information processing device 1, the amplitude of the pump signal at the start of quantum annealing can be set to a relatively large value, and the quantum bit value in the estimated solution can be relatively strongly reflected as the initial state of the quantum bit element 110. According to the information processing device 1, in this regard, in a case where the estimated solution is close to the desired solution such as an optimal solution, it is expected that the desired solution such as an optimal solution can be particularly easily obtained.

After initializing the quantum state of the quantum bit element 110 using the coherent drive signal, the control unit 200 controls the quantum calculation circuit 100 in such a way that the detuning of the quantum bit element 110 is made larger and then smaller, and the amplitude of the pump signal is made larger.

According to the information processing device 1, the amplitude of the pump signal at the start of quantum annealing can be set to a relatively small value such as 0, for example, and the quantum bit value in the estimated solution can be relatively weakly reflected as the initial state of the quantum bit element 110. According to the information processing device 1, in this regard, even in a case where the estimated solution is slightly far from the desired solution such as an optimal solution, it is expected that the desired solution such as an optimal solution can be relatively easily obtained.

In a case where the estimated solution obtained by the initialization of the quantum state of the quantum bit element 110 and the solution search under the control of the quantum calculation circuit 100 is different from the estimated solution set in the quantum bit element 110 in the initialization of the quantum state of the quantum bit element 110, the control unit 200 initializes the quantum state of the quantum bit element 110 in such a way that the estimated solution obtained by the solution search becomes an initial value, and performs the solution search again under the control of the quantum calculation circuit 100.

According to the information processing device 1, it is expected that the possibility of obtaining a desired solution such as an optimal solution becomes higher. Specifically, according to the information processing device 1, by changing the estimated solution set as the initial state of the quantum bit element 110 and repeatedly performing solution search by quantum annealing, it is expected that the possibility of setting an estimated solution that makes it easy to obtain a desired solution such as an optimal solution becomes relatively high.

In a case where the estimated solution obtained by the initialization of the quantum state of the quantum bit element 110 and the solution search under the control of the quantum calculation circuit 100 is equal to the estimated solution set in the quantum bit element 110 in the initialization of the quantum state of the quantum bit element 110, the control unit 200 changes at least one of the maximum value of detuning, the minimum value of the amplitude of the pump signal, or the estimated solution set as the initial state of the quantum state of the quantum bit element 110, and performs the initialization of the quantum state of the quantum bit element 110 and the solution search under the control of the quantum calculation circuit 100 again.

According to the information processing device 1, it is expected that the possibility of obtaining a desired solution such as an optimal solution becomes higher.

Specifically, according to the information processing device 1, by changing at least one of the maximum value of detuning, the minimum value of the amplitude of the pump signal, or the estimated solution set as the initial state of the quantum state of the quantum bit element 110 and repeatedly performing the solution search by quantum annealing, it is expected that there is a relatively high possibility of setting the detuning, the pump signal, and the estimated solution that facilitate obtaining a desired solution such as an optimal solution.

### Second Example Embodiment

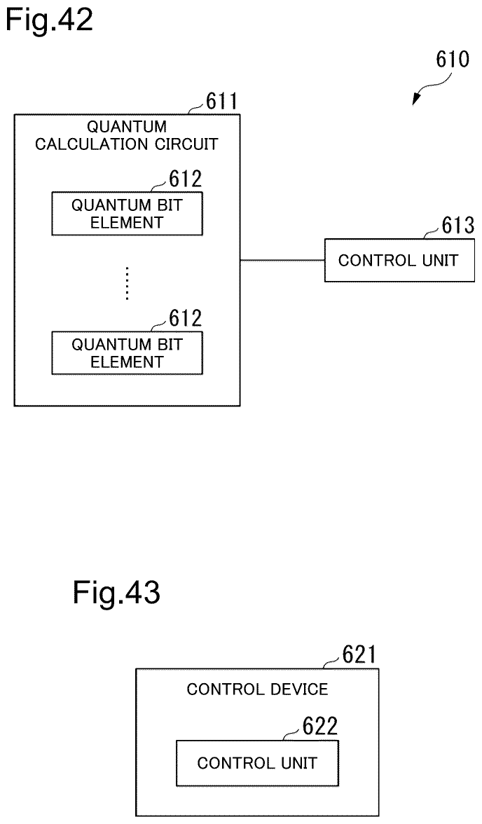

FIG. 42 is a diagram illustrating an example of a configuration of an information processing device according to at least one example embodiment.

In the configuration illustrated in FIG. 42, an information processing device 610 includes a quantum calculation circuit 611 and a control unit 613. The quantum calculation circuit 611 includes a quantum bit element 612.

In such a configuration, the quantum bit element 612 is a quantum bit element using a parametric oscillator having Kerr nonlinearity.

The control unit 613 initializes the quantum state of the quantum bit element 612 in such a way as to indicate any one of the binary values of the quantum bit using a coherent drive signal, and then controls the quantum calculation circuit 611 in such a way as to further increase the detuning of the quantum bit element 612.

The control unit 613 corresponds to an example of a controller.

According to the information processing device 610, in a case where a solution candidate is obtained when a solution search is performed using a Kerr parametric oscillator, the obtained solution candidate can be reflected in the solution search. Specifically, the information processing device 610 can initialize the quantum state of the quantum bit element 612 using the Kerr parametric oscillator in such a way as to indicate the quantum bit value in the solution candidate, and perform the solution search by quantum annealing. As a result, in the information processing device 610, it is expected that a desired solution such as an optimal solution can be easily obtained depending on the solution candidate set as the initial state of the quantum bit element 612.

### Third Example Embodiment

FIG. 43 is a diagram illustrating an example of a configuration of a control device according to at least one example embodiment. In the configuration illustrated in FIG. 43, a control device 620 includes a control unit 621.

In such a configuration, the control unit 621 controls a quantum calculation circuit including a quantum bit element using a parametric oscillator having Kerr nonlinearity in such a way that the quantum state of the quantum bit element is initialized to indicate any one of the binary values of the quantum bit using a coherent drive signal, and then the detuning of the quantum bit element is further increased.

The control unit 621 corresponds to an example of a controller.

According to the control device 620, in a case where a solution candidate is obtained when a solution search is performed using a Kerr parametric oscillator, the obtained solution candidate can be reflected in the solution search. Specifically, the control device 620 can initialize the quantum state of the quantum bit element using the Kerr parametric oscillator in such a way as to indicate the quantum bit value in the solution candidate, and perform the solution search by quantum annealing. As a result, in the control device 620, it is expected that a desired solution such as an optimal solution can be easily obtained depending on the solution candidate set as the initial state of the quantum bit element.

### Fourth Example Embodiment

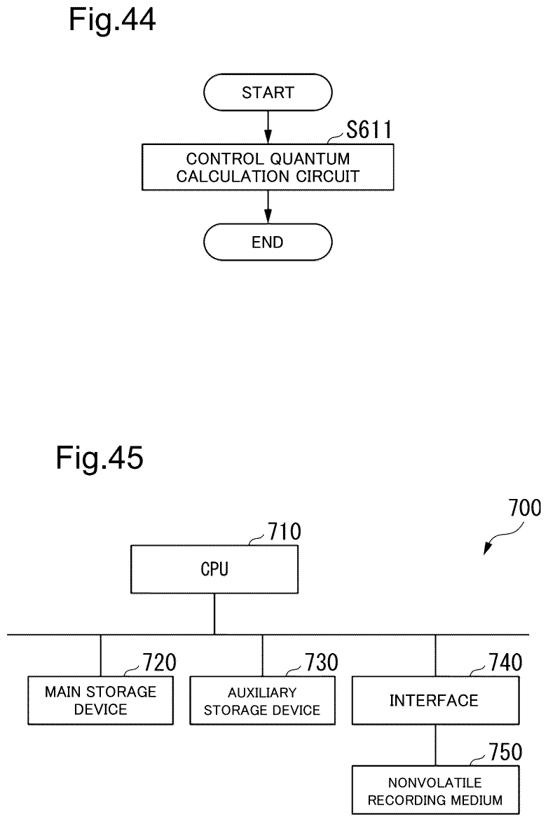

FIG. 44 is a diagram illustrating an example of a procedure of processing in an information processing method according to at least one example embodiment. The information processing method illustrated in FIG. 44 includes controlling a quantum calculation circuit (step S611).

In controlling the quantum calculation circuit (step S611), a computer for controlling the quantum calculation circuit including a quantum bit element having Kerr nonlinearity controls the quantum calculation circuit to initialize the quantum state of the quantum bit element in such a way as to indicate any one of the binary values of the quantum bit using a coherent drive signal and then increase the detuning of the quantum bit element.

According to the information processing method illustrated in FIG. 44, in a case where a solution candidate is obtained when a solution search is performed using a Kerr parametric oscillator, the obtained solution candidate can be reflected in the solution search. Specifically, in the information processing method illustrated in FIG. 44, the quantum state of the quantum bit element using the Kerr parametric oscillator is initialized in such a way as to indicate the quantum bit value in the solution candidate, and the solution search by the quantum annealing can be performed. As a result, in the information processing method illustrated in FIG. 44, it is expected that a desired solution such as an optimal solution can be easily obtained depending on a solution candidate set as the initial state of the quantum bit element.

FIG. 45 is a diagram illustrating an example of a configuration of a computer according to at least one example embodiment.

In the configuration illustrated in FIG. 45, a computer 700 includes a CPU 710, a main storage device 720, an auxiliary storage device 730, an interface 740, and a nonvolatile recording medium 750.

Any one or more of the control unit 200, the control unit 613, and the control device 620 or a part thereof may be mounted on the computer 700. In this case, the operation of each processing unit described above is stored in the auxiliary storage device 730 in the form of a program. The CPU 710 reads the program from the auxiliary storage device 730, loads the program in the main storage device 720, and executes the above processing according to the program. The CPU 710 secures a storage area related to each of the above-described storage units in the main storage device 720 according to the program. Communication between each device and another device is executed by the interface 740 having a communication function and performing communication under the control of the CPU 710. The interface 740 has a port for the nonvolatile recording medium 750, and reads information from the nonvolatile recording medium 750 and writes information to the nonvolatile recording medium 750.

In a case where the control unit 200 is implemented in the computer 700, the operation thereof is stored in the auxiliary storage device 730 in the form of a program. The CPU 710 reads the program from the auxiliary storage device 730, loads the program in the main storage device 720, and executes the above processing according to the program.

The CPU 710 secures a storage area for the control unit 200 to perform processing in the main storage device 720 according to the program. Communication between the control unit 200 and another device is executed by the interface 740 having a communication function and operating under the control of the CPU 710. The interaction between the control unit 200 and the user is executed when the interface 740 has an input device and an output device, information is presented to the user by the output device according to the control of the CPU 710, and a user operation is accepted by the input device.

In a case where the control unit 613 is implemented in the computer 700, the operation thereof is stored in the auxiliary storage device 730 in the form of a program. The CPU 710 reads the program from the auxiliary storage device 730, loads the program in the main storage device 720, and executes the above processing according to the program.

The CPU 710 secures a storage area for the control unit 613 to perform processing in the main storage device 720 according to the program. Communication between the control unit 613 and another device is executed by the interface 740 having a communication function and operating under the control of the CPU 710. The interaction between the control unit 613 and the user is executed when the interface 740 has an input device and an output device, information is presented to the user by the output device according to the control of the CPU 710, and a user operation is accepted by the input device.

In a case where the control device 620 is implemented in the computer 700, the operation of the control unit 621 is stored in the auxiliary storage device 730 in the form of a program. The CPU 710 reads the program from the auxiliary storage device 730, loads the program in the main storage device 720, and executes the above processing according to the program.

The CPU 710 secures a storage area for the control device 620 to perform processing in the main storage device 720 according to the program. Communication between the control device 620 and another device is executed by the interface 740 having a communication function and operating under the control of the CPU 710.

The interaction between the control device 620 and the user is executed when the interface 740 includes an input device and an output device, information is presented to the user by the output device according to the control of the CPU 710, and a user operation is received by the input device.

Any one or more of the above-described programs may be recorded in the nonvolatile recording medium 750. In this case, the interface 740 may read the program from the nonvolatile recording medium 750. The CPU 710 may directly execute the program read by the interface 740, or may temporarily store the program in the main storage device 720 or the auxiliary storage device 730 and execute the program.

A program for executing all or a part of the processing performed by the control unit 200, the control unit 613, and the control device 620 may be recorded in a computer-readable recording medium, and the processing of each unit may be performed by causing a computer system to read and execute the program recorded in the recording medium. The “computer system” herein includes an operating system (OS) and hardware such as peripheral devices.

The “computer-readable recording medium” refers to a portable medium such as a flexible disk, a magneto-optical disk, a read only memory (ROM), and a compact disc read only memory (CD-ROM), and a storage device such as a hard disk built in a computer system. The program may be for implementing some of the functions described above, and the functions described above may be implemented in combination with a program already recorded in the computer system.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above example embodiments can also be described as the following supplementary notes, but are not limited to the following.

### Supplementary Note 1

An information processing device including
a quantum calculation circuit and a controller, in which
the quantum calculation circuit includes a quantum bit element using a parametric oscillator having Kerr nonlinearity, and
the controller initializes a quantum state of the quantum bit element in such a way as to indicate any one of binary values of the quantum bit using a coherent drive signal, and then controls the quantum calculation circuit in such a way as to increase detuning of the quantum bit element.

### Supplementary Note 2

The information processing device according to supplementary note 1, in which
after initializing the quantum state of the quantum bit element using the coherent drive signal, the controller controls the quantum calculation circuit in such a way as to make the detuning of the quantum bit element larger and then smaller, and to make an amplitude of a pump signal smaller and then larger.

### Supplementary Note 3

The information processing device according to supplementary note 1, in which
after initializing the quantum state of the quantum bit element using the coherent drive signal, the controller controls the quantum calculation circuit in such a way as to make the detuning of the quantum bit element larger and then smaller, and to make an amplitude of a pump signal larger.

### Supplementary Note 4

The information processing device according to any one of supplementary notes 1 to 3, in which
in a case where a solution obtained by the initialization of the quantum state of the quantum bit element and a solution search under control of the quantum calculation circuit is different from a solution set in the quantum bit element in the initialization of the quantum state of the quantum bit element, the controller initializes the quantum state of the quantum bit element in such a way that the solution obtained by the solution search becomes an initial value, and performs the solution search again under the control of the quantum calculation circuit.

### Supplementary Note 5

The information processing device according to any one of supplementary notes 1 to 4, in which
in a case where the solution obtained by the initialization of the quantum state of the quantum bit element and a solution search under control of the quantum calculation circuit is equal to a solution set in the quantum bit element in the initialization of the quantum state of the quantum bit element, the controller changes at least one of a maximum value of the detuning, a minimum value of an amplitude of a pump signal, or a solution set as the initial state of the quantum state of the quantum bit element, and performs the initialization of the quantum state of the quantum bit element and the solution search under control of the quantum calculation circuit again.

### Supplementary Note 6

A control device including
a controller for controlling a quantum calculation circuit including a quantum bit element using a parametric oscillator having Kerr nonlinearity in such a way that a quantum state of the quantum bit element is initialized to indicate any one of binary values of the quantum bit using a coherent drive signal, and then detuning of the quantum bit element is further increased.

### Supplementary Note 7

The control device according to supplementary note 6, in which
after initializing the quantum state of the quantum bit element using the coherent drive signal, the controller controls the quantum calculation circuit in such a way as to make the detuning of the quantum bit element larger and then smaller, and to make an amplitude of a pump signal smaller and then larger.

### Supplementary Note 8

The control device according to supplementary note 6, in which
after initializing the quantum state of the quantum bit element using the coherent drive signal, the controller controls the quantum calculation circuit in such a way as to make the detuning of the quantum bit element larger and then smaller, and to make an amplitude of a pump signal larger.

### Supplementary Note 9

The control device according to any one of supplementary notes 6 to 8, in which
in a case where a solution obtained by the initialization of the quantum state of the quantum bit element and a solution search under control of the quantum calculation circuit is different from a solution set in the quantum bit element in the initialization of the quantum state of the quantum bit element, the controller initializes the quantum state of the quantum bit element in such a way that the solution obtained by the solution search becomes an initial value, and performs the solution search again under the control of the quantum calculation circuit.

### Supplementary Note 10

The control device according to any one of supplementary notes 6 to 9, in which
in a case where the solution obtained by the initialization of the quantum state of the quantum bit element and a solution search under control of the quantum calculation circuit is equal to a solution set in the quantum bit element in the initialization of the quantum state of the quantum bit element, the controller changes at least one of a maximum value of the detuning, a minimum value of an amplitude of a pump signal, or a solution set as the initial state of the quantum state of the quantum bit element, and performs the initialization of the quantum state of the quantum bit element and the solution search under control of the quantum calculation circuit again.

### Supplementary Note 11

An information processing method including
a computer for controlling a quantum calculation circuit including a quantum bit element having Kerr nonlinearity
controlling the quantum calculation circuit to initialize a quantum state of the quantum bit element in such a way as to indicate any one of binary values of the quantum bit using a coherent drive signal, and then increase detuning of the quantum bit element.

### Supplementary Note 12

The information processing method according to supplementary note 11, further including,
after initializing the quantum state of the quantum bit element using the coherent drive signal, the computer controlling the quantum calculation circuit in such a way as to make the detuning of the quantum bit element larger and then smaller, and to make an amplitude of a pump signal smaller and then larger.

### Supplementary Note 13

The information processing method according to supplementary note 11, further including,
after initializing the quantum state of the quantum bit element using the coherent drive signal, the computer controlling the quantum calculation circuit in such a way as to make the detuning of the quantum bit element larger and then smaller, and to make an amplitude of a pump signal larger.

### Supplementary Note 14

The information processing method according to any one of supplementary notes 11 to 13, further including,
in a case where a solution obtained by the initialization of the quantum state of the quantum bit element and a solution search under control of the quantum calculation circuit is different from a solution set in the quantum bit element in the initialization of the quantum state of the quantum bit element, the computer initializing the quantum state of the quantum bit element in such a way that the solution obtained by the solution search becomes an initial value, and performing the solution search again under the control of the quantum calculation circuit.

### Supplementary Note 15

The information processing method according to any one of supplementary notes 11 to 14, further including,
in a case where the solution obtained by the initialization of the quantum state of the quantum bit element and a solution search under control of the quantum calculation circuit is equal to a solution set in the quantum bit element in the initialization of the quantum state of the quantum bit element, the computer changing at least one of a maximum value of the detuning, a minimum value of an amplitude of a pump signal, or a solution set as the initial state of the quantum state of the quantum bit element, and performing the initialization of the quantum state of the quantum bit element and the solution search under control of the quantum calculation circuit again.

### Supplementary Note 16

A program causing a computer for controlling a quantum calculation circuit including a quantum bit element having Kerr nonlinearity to execute
controlling the quantum calculation circuit to initialize a quantum state of the quantum bit element in such a way as to indicate any one of binary values of the quantum bit using a coherent drive signal, and then increase detuning of the quantum bit element.

### Supplementary Note 17

The program according to supplementary note 16, further causing the computer to execute,
after initializing the quantum state of the quantum bit element using the coherent drive signal, controlling the quantum calculation circuit in such a way as to make the detuning of the quantum bit element larger and then smaller, and to make an amplitude of a pump signal smaller and then larger.

### Supplementary Note 18

The program according to supplementary note 16, further causing the computer to execute,
after initializing the quantum state of the quantum bit element using the coherent drive signal, controlling the quantum calculation circuit in such a way as to make the detuning of the quantum bit element larger and then smaller, and to make an amplitude of a pump signal larger.

### Supplementary Note 19

The program according to any one of supplementary notes 16 to 18, further causing the computer to execute,
in a case where a solution obtained by the initialization of the quantum state of the quantum bit element and a solution search under control of the quantum calculation circuit is different from a solution set in the quantum bit element in the initialization of the quantum state of the quantum bit element, initializing the quantum state of the quantum bit element in such a way that the solution obtained by the solution search becomes an initial value, and performing the solution search again under the control of the quantum calculation circuit.

### Supplementary Note 20

The program according to any one of supplementary notes 16 to 19, further causing the computer to execute,
in a case where the solution obtained by the initialization of the quantum state of the quantum bit element and a solution search under control of the quantum calculation circuit is equal to a solution set in the quantum bit element in the initialization of the quantum state of the quantum bit element, changing at least one of a maximum value of the detuning, a minimum value of an amplitude of a pump signal, or a solution set as the initial state of the quantum state of the quantum bit element, and performing the initialization of the quantum state of the quantum bit element and the solution search under control of the quantum calculation circuit again.

### Supplementary Note 21

A non-transitory recording medium readable by at least one computer, the non-transitory recording medium recording program causing a computer for controlling a quantum calculation circuit including a quantum bit element having Kerr nonlinearity to execute
controlling the quantum calculation circuit to initialize a quantum state of the quantum bit element in such a way as to indicate any one of binary values of the quantum bit using a coherent drive signal, and then increase detuning of the quantum bit element.

1. An information processing device comprising
a quantum calculation circuit and a controller, wherein
the quantum calculation circuit includes a quantum bit element using a parametric oscillator having Kerr nonlinearity, and
the controller includes a memory storing instructions; and
one or more processors configured to execute the instructions to:
initialize a quantum state of the quantum bit element in such a way as to indicate any one of binary values of the quantum bit using a coherent drive signal; and
then control the quantum calculation circuit in such a way as to increase detuning of the quantum bit element.

2. The information processing device according to claim 1, wherein the one or more processors of the controller are further configured to execute the instructions to:
after initializing the quantum state of the quantum bit element using the coherent drive signal, control the quantum calculation circuit in such a way as to make the detuning of the quantum bit element larger and then smaller, and to make an amplitude of a pump signal smaller and then larger.

3. The information processing device according to claim 1, wherein the one or more processors of the controller are further configured to execute the instructions to:
after initializing the quantum state of the quantum bit element using the coherent drive signal, control the quantum calculation circuit in such a way as to make the detuning of the quantum bit element larger and then smaller, and make an amplitude of a pump signal larger.

4. The information processing device according to claim 1, wherein the one or more processors of the controller are further configured to execute the instructions to:
in a case where a solution obtained by the initialization of the quantum state of the quantum bit element and a solution search under control of the quantum calculation circuit is different from a solution set in the quantum bit element in the initialization of the quantum state of the quantum bit element, the controller initializes the quantum state of the quantum bit element in such a way that the solution obtained by the solution search becomes an initial value, and performs the solution search again under the control of the quantum calculation circuit.

5. The information processing device according to claim 1, wherein the one or more processors of the controller are further configured to execute the instructions to: in a case where the solution obtained by the initialization of the quantum state of the quantum bit element and a solution search under control of the quantum calculation circuit is equal to a solution set in the quantum bit element in the initialization of the quantum state of the quantum bit element, change at least one of a maximum value of the detuning, a minimum value of an amplitude of a pump signal, or a solution set as the initial state of the quantum state of the quantum bit element, and perform the initialization of the quantum state of the quantum bit element and the solution search under control of the quantum calculation circuit again.

6. A control device comprising
a memory storing instructions; and
one or more processors configured to execute the instructions to:
control a quantum calculation circuit including a quantum bit element using a parametric oscillator having Kerr nonlinearity in such a way that a quantum state of the quantum bit element is initialized to indicate any one of binary values of the quantum bit using a coherent drive signal, and then detuning of the quantum bit element is further increased.

7. An information processing method comprising
a computer for controlling a quantum calculation circuit including a quantum bit element having Kerr nonlinearity
controlling the quantum calculation circuit to initialize a quantum state of the quantum bit element in such a way as to indicate any one of binary values of the quantum bit using a coherent drive signal, and then increase detuning of the quantum bit element.
